(19) United States
(12) Patent Application Publication
(10) Pub. No.: US 2006/0047547 A1
(43) Pub. Date: Mar. 2, 2006

(54) System and method for automated product design and approval

(76) Inventors: Jon D. Ekker, Billings, MT (US); Ben Trerise, Billings, MT (US)

Correspondence Address: Antoinette M. Tease, P.L.L.C., P.O. Box 51016, Billings, MT, 59105, US

(21) Appl. No.: 10/925,690

(22) Filed: Aug. 25, 2004

(51) Int. Cl. G06F 17/60

(52) U.S. Cl. 705/8

(57) ABSTRACT

The present invention is a system for automated product design and approval comprising a design creation and approval subsystem, an ordering and quotation subsystem, a purchase authorization subsystem, a work orders and production subsystem, a shipping subsystem and an invoicing subsystem. The system includes numerous features that facilitate product design and approval, such as creation of a product template by selecting a product category and subcategory from a dropdown menu, a design request form, an interactive movie for design edits, and generation of a purchase authorization when a design has been approved. The system automatically generates Supplier quote forms, Manufacturer quote forms, Company quote forms, purchase orders, work orders, packing slips and electronic invoices. The system has automated calendaring and notification features and allows product images and source art files to be uploaded. A method of using the automated system described above.

### BACKGROUND OF THE INVENTION

1. Field of the Invention

The present invention relates to the field of e-business. More particularly, the present invention involves an automated system that allows product designs to be created, reviewed, modified and approved online by the various individuals involved in the design process, including graphic artists, customers, product developers, suppliers, manufacturers and administrators.

2. Description of the Related Art

A number of automated systems have been developed for handling various aspects of e-commerce, from marketing and processing orders to managing inventory and supply chains. None of these systems, however, provides the dynamic, real-time product design features of the present invention. In today's increasingly Internet-based economy, there is a need for an automated system that allows users to create, review, modify and approve product designs online.

U.S. patent application Nos. 2002/0099577 (Black), 2003/0069766 (Hoffman), and 2004/0064351 (Mikurak) are illustrative of the kinds of patent applications that are currently pending in the field of e-commerce. U.S. patent application No. 2002/0099577 (Black) involves a virtual production link system for media production. The system comprises a vendor database, a service company database, date availability information for both the vendor and service company databases, a budget program, and an auction program. The Black system is somewhat similar to the present invention in that it involves coordination of vendors and service providers, it allows for the submission of bids, and it facilitates production of the end product, but it departs from the present invention in its application and lack of product design features.

The Black system is intended to be used for media production, primarily in the entertainment industry. In the preferred embodiment, the vendor and service company databases include information on camera, audio, lighting, wardrobe, set construction, film and video, and studio or stage rental and/or sales companies. Thus, the emphasis of the Black application is not on production of a physical product (like a t-shirt) but on production of a television show, film, video, commercial or audio recording. Furthermore, the Black system does not involve design of the product but only production of the product. With its emphasis on scheduling and budgeting, the Black system is more like a project management tool than a product design application.

U.S. patent application No. 2003/0069766 (Hoffman) is entitled “Supply chain management framework interface.” This application covers a method, computer program and system for “navigating a user in a network-based supply chain management interface.” The method comprises assigning an identifier to a plurality of stores, distributors and suppliers; receiving a request for access to a database from a store, distributor or supplier; identifying the entity that placed the request through its identifier; displaying a particular page to the user based on whether it is a store, distributor or supplier; and extracting relevant information from the database. The claims that are directed to a computer program and a system are similar to the method claims.

The Hoffman system does not include any of the design features of the present invention. It was originally developed for the restaurant services industry to enable restaurants to manage their own supply chains. It does not involve interaction with customers, and it does not relate to the actual creation of a product. Instead, it was intended to increase communications between different participants in the supply chain and to give companies the data they need to improve their marketing strategies.

Like the Hoffman patent application, U.S. patent application No. 2004/0064351 (Mikurak) is directed toward solving problems associated with supply chain management. This patent application contemplates that a first business entity will act as a liaison between a second and third business entity, which may be a service provider, vendor, reseller or manufacturer. The first business entity receives an order from the second business entity, transmits that order to the third business entity, tracks the third entity's progress in completing the order, and provides progress reports to the second business entity. The application includes method claims, as well as claims to a system and computer program.

The Mikurak application does not include any of the design features of the present invention. Its primary function is to facilitate transactions between business entities. The first business entity is not responsible for creating a product, and the customer is not able to review, modify and approve the product online. In the context of the Mikurak application, the product has already been made, someone wants to buy it, and the Mikurak application allows the first business entity to match the supplier up with the buyer.

There are numerous e-commerce patents and patent applications in addition to the three described above; however, none of the patents that have issued or applications that have been published to date have included the unique product design aspects of the present invention. The present invention has been developed to fulfill the need for an automated product design process. It is an object of the present invention to provide a system that allows users to (i) create new products and request changes to those products, (ii) prioritize design requests, (iii) create design request lists for graphic artists, (iv) upload ideas for product designs for the graphic artists to consider, (v) upload designs for customers to review, (vi) upload source art for manufacturers to use in manufacturing the product; (vii) view information relating to the status of the product design; (viii) create multiple graphic sizes from a single uploaded image; and (ix) approve designs online.

### BRIEF SUMMARY OF THE INVENTION

The present invention is a system for automated product design and approval comprising a design creation and approval subsystem, an ordering and quotation subsystem, a purchase authorization subsystem, a work orders and production subsystem, a shipping subsystem and an invoicing subsystem. The design creation and approval subsystem comprises a main design page with product categories and subcategories, product colors, and methods of production. The product categories and subcategories can be modified by a Company Administrator, the product colors can be added to, removed or modified by a Company Administrator, and the methods of production can be added to, removed or modified by a Company Administrator. A product template is created by selecting the product category and subcategory from a dropdown menu, and a design request is input into a design request form that is embedded within the main design page.

The product color(s) and size specifications are selected by a Product Developer when the product template is created, the product name is entered by a Product Developer when the product category and subcategory are selected, and the system generates a unique design code for each product. The design request can include an image that is uploaded by the person submitting the design request. A Graphic Artist is selected from a dropdown menu, and the design request appears on the Graphic Artist's home page. The design request can include a priority designation, and the design requests on the Graphic Artist's home page are automatically ordered by the system according to the priority designation and date of the request.

After completing a design request, the Graphic Artist clicks a checkbox next to the design request on his or her home page, and the Product Developer receives an email indicating that the design request has been fulfilled. The Graphic Artist then uploads a new product image with a design element to replace the product template that was created upon selection of the product category.

The system creates three separate image files for the product image—a thumbnail image, a mid-size image, and a full-size image. The thumbnail image appears on the quoting, purchase authorization and work order pages. The mid-size image appears on the Supplier quote, the Manufacturer quote, the Company quote, the work order, the purchase order, the packing slip, and the invoice. The full-size image is available on the main design page and also by clicking on the mid-size or thumbnail image.

The Product Developer can request design changes using either a design request form or an interactive Flash movie feature. In connection with the Flash movie feature, the Product Developer can change the location of the design element by clicking and dragging the design element to a new location on the product, and the Product Developer can also change the size of the design element by moving a bar along a slide that increases or decreases the design element size. The product is approved by the Product Developer by clicking a button on the main design page.

The system automatically categorizes products according to the following design stage categories: design, approved, catalog and deleted. Products can be manually added to the line category by a Product Developer or Company Administrator. In addition, all of the products that have been created for a particular Product Developer are shown in the order of creation on the main design page. The system stores a list of all design changes, and the list of design changes is accessible from a link on the main design page.

The ordering and quotation subsystem comprises an order page that lists those products that have been approved. The order page includes size boxes that correlate to the category and subcategory of the product. The order page indicates whether a particular product subcategory is available in certain sizes. The order page also includes a complete purchase authorization history. An order is created by entering quantities into the size boxes and clicking the order button, and the system sends emails to one or more Company Administrator(s), a Product Developer and a Client when an order is created. A posting is also made to the home pages of the Company Administrator(s), Product Developer and Client when an order is created.

The order also appears on a Company “Requested Orders” page, from which a Company Administrator selects one or more Supplier(s) and Manufacturer(s) from whom to solicit quotes. If the order is a reorder, the system automatically selects the Supplier and Manufacturer that produced the goods for the previous order. The system sends emails to the selected Supplier(s) and Manufacturer(s) informing them of the request for a quote and providing them with instructions on how to log in to the system and fill out a quote form. The method of production is automatically indicated on the Manufacturer's quote form.

When quotes are submitted by the Supplier(s) and Manufacturer(s), the system sends an email to one or more Company Administrator(s), and a Company Administrator accepts one Supplier quote and one Manufacturer quote. If the same company will be acting both as the Supplier and the Manufacturer, then the Company need only accept one quote from that company.

The system generates a Company quote form, which includes the accepted Supplier and Manufacturer quotes, a table setting forth markup percentages for each Client, and a default markup percentage for each quote received. The system also adds a Graphic Artist commission and a Product Developer commission, if applicable, to the Company quote form. The Company Administrator has the ability to review and accept the Company quote or change the markup percentages and/or commissions before accepting the Company quote.

When a Company quote is accepted, the system generates a purchase authorization and sends an email to a Product Developer and a Client requesting approval or rejection of the purchase authorization. The purchase authorization subsystem comprises a purchase authorization report, and a purchase authorization is approved through the use of an embedded form in the purchase authorization report. When a purchase authorization is accepted by the Client, the system sends an email to a Product Developer and Company Administrator(s) informing them that the purchase authorization has been accepted. The system also sends an email to the Supplier and Manufacturer informing them that the job has been approved for production.

Upon acceptance of a purchase authorization, the system automatically sends a purchase order to the Supplier and a work order to the Manufacturer. The Graphic Artist can upload a design image source art file for the Manufacturer to use in producing the product, and the Manufacturer can upload a digital image of a product sample into the work order.

Once the Manufacturer notifies the Company of the completion of production, the system automatically generates a packing slip that is physically attached to the boxes of product to be shipped. The system provides a click-and-drag application that allows the user to organize boxes of product by size. The system also sends emails to one or more Company Administrators, a Client, a Product Developer, and the receiving locations informing them that the product is being shipped. In addition, the system generates an electronic invoice and sends the invoice together with an email to a Client and one or more Company Administrators.

The system includes a calendar feature that selectively displays information to a user depending on the user's profile within the system (i.e., Client, Product Developer, Manufacturer, etc.). Approved purchase authorizations are automatically displayed on the calendar on their corresponding ship dates. The approved purchase authorization that is displayed on the calendar includes the order number, quantity, Manufacturer and a thumbnail image of the product. The system automatically updates the ship date throughout the system if the ship date is changed in the calendar. Conversely, the purchase authorization that is displayed on the calendar is automatically moved if the ship date for that purchase authorization is changed in another part of the system. Whenever a ship date is changed, the user is notified of the change in ship date when he or she logs into the system or accesses the calendar.

The present invention also covers a method of using the system described above for automated product design and approval. The method comprises the steps of: creating a product template by selecting the product category and subcategory; submitting a design request; reviewing the image of the product that has been uploaded by the Graphic Artist after he or she completes the design work; approving the design; selecting the product size(s); reviewing and approving a purchase authorization; and receiving an electronic invoice.

### BRIEF DESCRIPTION OF THE DRAWINGS

FIG. 1 is a screen shot showing the product categories and subcategories for one of the product categories (in this case, outerwear).

FIG. 2 is a screen shot of the template used by the Company Administrator to describe or modify a product subcategory.

FIG. 3 is a screen shot illustrating the various methods of production.

FIG. 4 is a screen shot of the main design page for a particular product.

FIG. 5 is a screen shot of the design request form.

FIG. 6 is a screen shot of the form for uploading an image for the Graphic Artist.

FIG. 7 is a screen shot of the main design page after the image has been uploaded.

FIG. 8 is a screen shot of the Graphic Artist's home page showing a design request.

FIG. 9 is a screen shot of the main design page after the Graphic Artist has uploaded the new image.

FIG. 10 is a screen shot of a Product Developer's pending purchase authorization page, which includes a thumbnail image of the product.

FIG. 11 is a screen shot of a purchase authorization page with a mid-size image of the product.

FIG. 12 is a screen shot of the edit form for changing the product or location names.

FIG. 13 is a screen shot of the edit form for changing the color names and size specifications for a design image on a particular product location.

FIG. 14 is a screen shot of the main design page after the product has been approved.

FIG. 15 is a screen shot of the interactive movie feature.

FIG. 16 is a screen shot of the main design page showing more than one product in the order of creation.

FIG. 17 is a screen shot of the logged design requests for a particular product.

FIG. 18 is a screen shot of the JavaScript-generated menu that is dynamically created when the Product Developer clicks the product name.

FIG. 19 is a diagram showing the various users that have access to the design creation and approval subsystem of the present invention.

FIG. 20 is a screen shot of the Product Developer's order page for a particular product.

FIG. 21 is a screen shot of the Company Administrator “Requested Orders” page showing a reorder of a particular product.

FIG. 22 is a screen shot of a blank Supplier quote form.

FIG. 23 is a screen shot of a blank Manufacturer quote form.

FIG. 24 is a screen shot of a completed Supplier quote.

FIG. 25 is a screen shot of a completed Manufacturer quote.

FIG. 26 is a screen shot of the Company Administrator “Quotes” page showing the quotes received from the Supplier(s) and Manufacturer(s) and the radio buttons for acceptance of the Supplier and Manufacturer quotes.

FIG. 27 is a screen shot of the Company quote form as filled out by the system before Company Administrator review.

FIG. 28 is a screen shot of a completed Company quote.

FIG. 29 is a diagram showing the various users that have access to the ordering and quotation subsystem of the present invention.

FIG. 30 is a screen shot of a pending purchase authorization from a client's “View PA's” page.

FIG. 31 is a screen shot of a purchase authorization report before it has been accepted.

FIG. 32 is a screen shot of a purchase authorization report after it has been accepted.

FIG. 33 is a screen shot of the form for uploading source art files for the Manufacturer.

FIG. 34 is a diagram showing the various users that have access to the purchase authorization subsystem of the present invention.

FIG. 35 is a screen shot of a purchase order.

FIG. 36 is a screen shot of a work order.

FIG. 37 is a screen shot of the form for uploading the digital image of the product.

FIG. 38 is a screen shot of the work order with the uploaded digital image of the actual product.

FIG. 39 is a diagram showing the various users that have access to the work orders and production subsystem of the present invention.

FIG. 40 is a screen shot of a blank packing slip with the default settings for shipper designation and expected arrival date.

FIG. 41 is a screen shot showing five created boxes, two of which have been filled using the click-and-drag procedure.

FIG. 42 is a screen shot of a completed packing slip.

FIG. 43 is a diagram showing the various users that have access to the shipping subsystem of the present invention.

FIG. 44 is a screen shot of an invoice before it is billed to the Client, including the email content form.

FIG. 45 is a diagram showing the various users that have access to the invoicing subsystem of the present invention.

FIG. 46 is an overview of the workflow of the entire system.

FIG. 47 is a screen shot of the calendar from the Client's perspective showing a purchase authorization entry that has been approved.

### DETAILED DESCRIPTION OF INVENTION

I. Overview and Definitions

The present invention is an online system that supports the entire process of designing, ordering and shipping of products for clients. The system is set up in a logical workflow progression that provides real-time data to all of the user groups associated with the system. The groups associated with the system include: Product Developers; Graphic Artists; Clients; Management Clients; Retailers; Suppliers/Manufacturers; and Company Employees. In this context, the term “Company” refers to the organization that owns and operates the system. Within the category of Company Employees there are two sub-profiles, which are Company Administrator and Standard Company Employee.

For purposes of this application, the following definitions apply:

The term “Product Developer” means a sales representative outside of the Company office who receives a commission based on sales.

The term “Graphic Artist” means a person who completes the design and logo work.

The term “Client” means the person who receives the work completed by the Graphic Artist and who approves the final product design. The Client is also the person who is purchasing the products.

The term “Management Client” means a person who represents the Client but who does not receive a commission.

The term “Supplier/Manufacturer” means a vendor that provides goods or services.

The term “Company Administrator” means a Company employee with unlimited access to the site, including access to all of the various profiles included on the site.

The term “Standard Company Employee” means a Company employee with limited access to the site. A Standard Company Employee has the same access to the system as a Company Administrator except that the Standard Company Employee does not have access to the quotation subsystem and cannot edit the account information for other users.

II. System Profiles

The system of the present invention is based on a number of different profiles that correspond to the user groups described above. All users have immediate access to the most current information contained in their respective profiles. When a user signs in, the system authenticates the user and determines what to display on his or her home page by the user's name and password. The particular functionality of each subsystem within the system is described more fully below. This section is intended to give the reader a general overview of the various profiles available on the system.

A Product Developer has his or her own profile or system home page. A Product Developer also has the ability to view those Client sites for which the Product Developer is responsible, and access to those sites is governed by a password. Even within a particular Client site, a Product Developer can only view information pertaining to the specific jobs and/or designs with which the Product Developer is involved. For example, if a Client were working with more than one Product Developer, each Product Developer would see only those jobs and/or designs for which that Product Developer was responsible.

Product Developers also have access to a reference section that displays information regarding previous jobs. Sales commissions for Product Developers are also posted in the reference section. Product Developers can also log into their Clients' sites to see what information their Clients have access to and to assist Clients in completing their sessions.

Graphic Artists have limited access to the system because they only see the designs on which they are currently working or that they have completed. Graphic Artists can also look up information relating to their commissions and receive communications from Product Developers, Clients, Company Administrators, Standard Company Employees concerning projects. The Graphic Artists' profile includes a page where job edits are posted with links to information regarding the relevant projects. Graphic Artists can complete the requested edits and instantly view projects associated with design edits.

Clients have limited access to the system in that they can view their designs and purchase authorizations, and they can also view all documents (e.g., purchase authorizations, packing slips and invoices) pertaining to their transactions. Clients can also receive communications relating to design approval, order approval, invoicing and shipping information. Clients receive this information either by postings to their home page, postings to the design site (to which Clients have access) or by email.

Management Clients have the same access as Product Developers. Management Clients typically work for the Client but do not receive commissions on sales.

Retailers can view a catalog of products available to the retail market. The catalog is updated instantly, which gives Retailers immediate access to new products and avoids problems associated with ordering discontinued products.

Suppliers have limited access to the site for the purpose of submitting quotes for particular projects and receiving purchase orders. Suppliers can view previous quotes for jobs in a reference section.

Manufacturers have limited access to the site for the purpose of submitting quotes for particular projects, receiving approved work orders, and downloading source art from the work order. Manufacturers can view previous quotes for jobs in a reference section. The system stores all of the necessary information regarding product design, which makes it easy for a new Manufacturer to make a product it has never made before, allows products to be produced faster, and ensures consistency of design standard throughout various parts of the world.

The Company profile includes two sub-profiles, which are the Company Administrator(s) and the Standard Company Employee(s). The Standard Company Employee profile includes a “to do” list for each Standard Company Employee. Entries in the “to do” list can be created and deleted by either a Company Administrator or Standard Company Employee.

Company Administrators have unlimited access to all aspects of and all profiles within the system. They can set credit amounts for each Client, as well as the markup percentages each Client will pay. Company Administrators can also log into any user's site and act as if they are that user. In addition, Company Administrators can use a special search feature that allows them to find almost anything in the system.

When an individual is added to the system, the Company Administrator creates an account for that individual and enters the account information (name, address, phone number, etc.) and specifies the type of user. When a new Client is first input into the system, an email is sent to the Company accountant to let him or her know there is a new Client and that a credit approval process must be undertaken.

III. Design Creation and Approval Subsystem

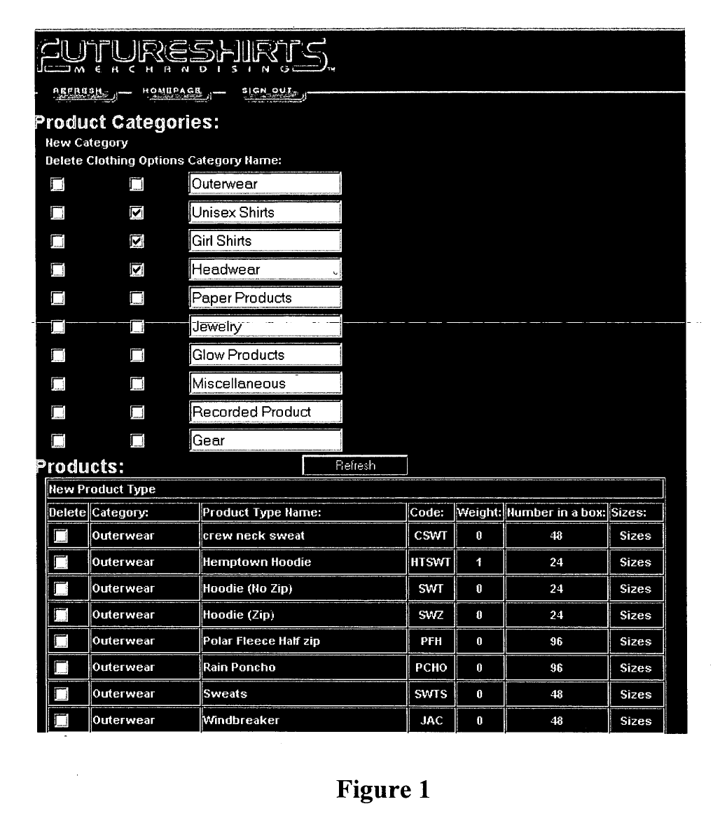

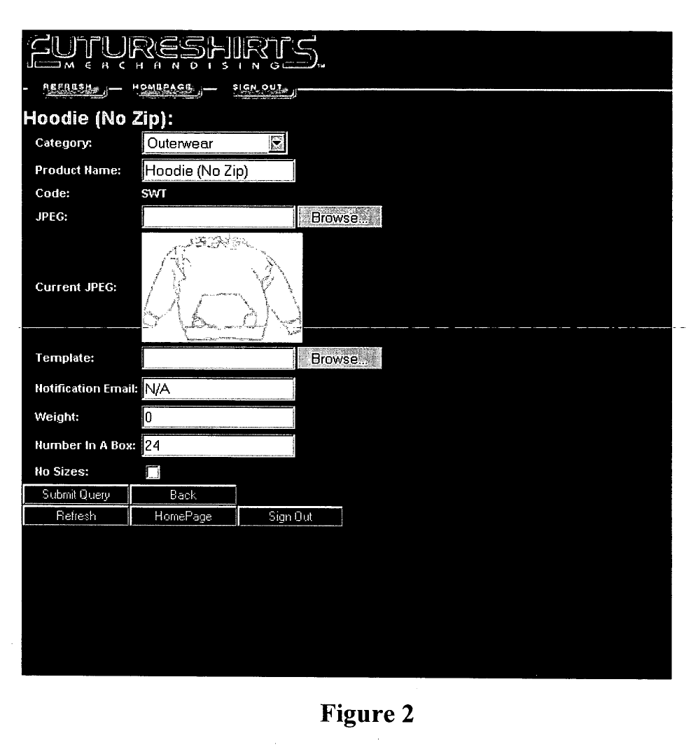

The design creation and approval subsystem is the most significant aspect of the present invention. This subsystem allows for the creation of new logos or other design elements for products by product category. By way of example, one embodiment of the present invention might include the following product types: unisex shirts, girl shirts, outerwear, headwear, paper products, jewelry, glow products and miscellaneous. Within these eight categories are subcategories that further classify and describe the product being created. The categories and subcategories are described and modified by a Company Administrator. The number of categories and subcategories that can be used is unlimited; therefore, literally any physical product can be designed online. FIG. 1 is a screen shot showing the product categories and subcategories for one of the product categories (in this case, outerwear). FIG. 2 is a screen shot of the template used by the Company Administrator to describe or modify a product subcategory.

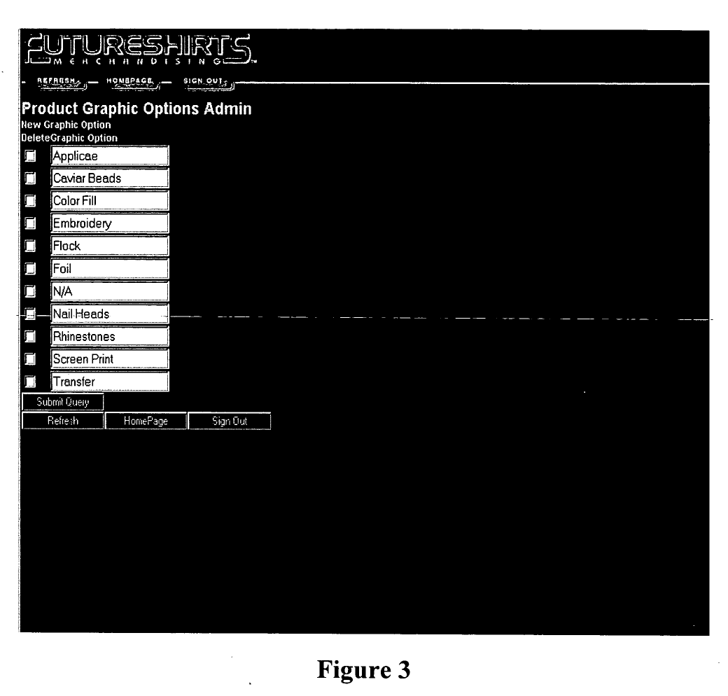

Product colors are also stored within the system and can be added to, removed or modified by the Company Administrator. The Company Administrator can also add, remove and modify methods of production, which are linked to the final products that are approved. The methods of production will vary depending on the product. In this case of a t-shirt, for example, the design image can be inserted onto the blank good by a number of different processes, including screen print, transfer, embroidery, rhinestones and foil, all of which would be considered methods of production. FIG. 3 is a screen shot illustrating the various methods of production.

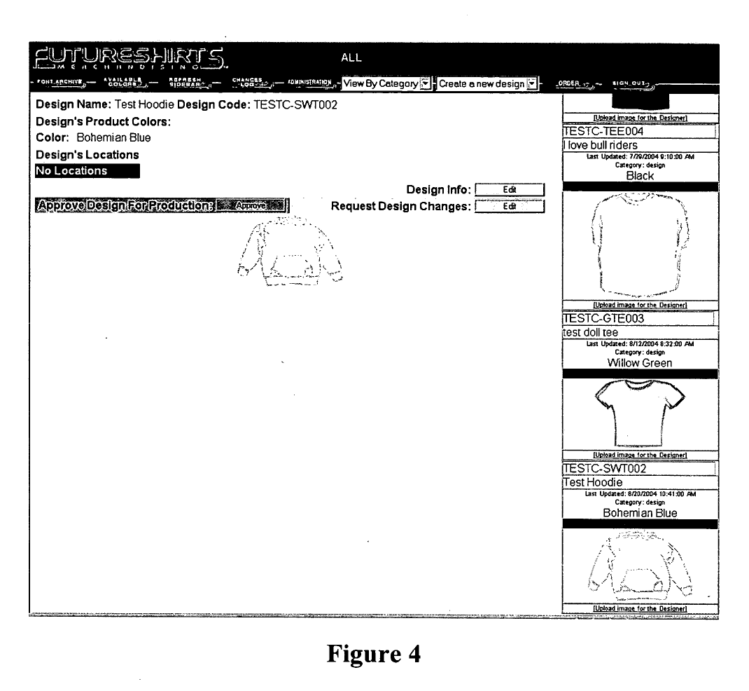

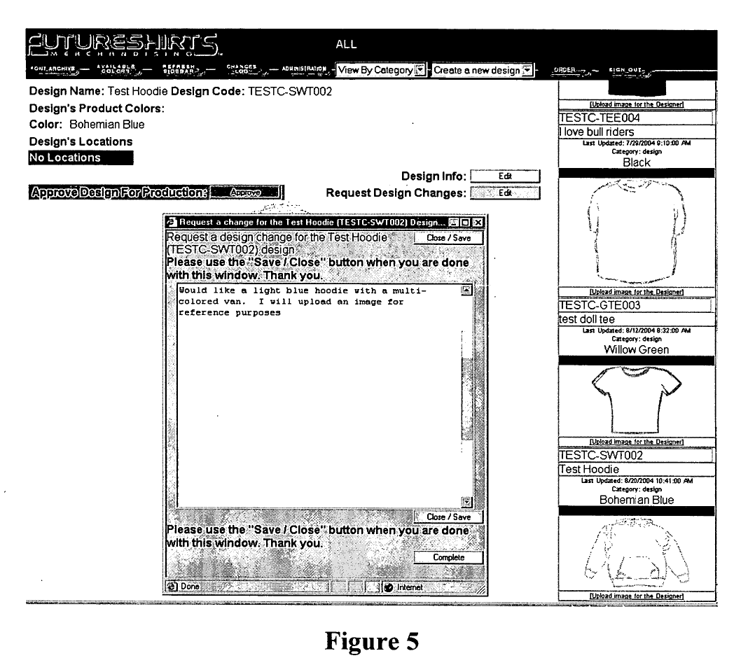

A Product Developer creates a product template by selecting the category of product from a dropdown menu. At that point, a design sidebar creates a blank template for the product with a blank filling (meaning there is no logo or other design indicated on the product) to indicate that there is no design associated with the product. FIG. 4 is a screen shot of the main design page for a particular product. In addition, a design request is input into a form that is embedded within the design page. FIG. 5 is a screen shot of the design request form.

Design sizes (width and height) can be input by the Product Developer, along with the design image colors. Alternatively, the Product Developer can ask the Graphic Artist to determine the appropriate size and color(s) for the design element.

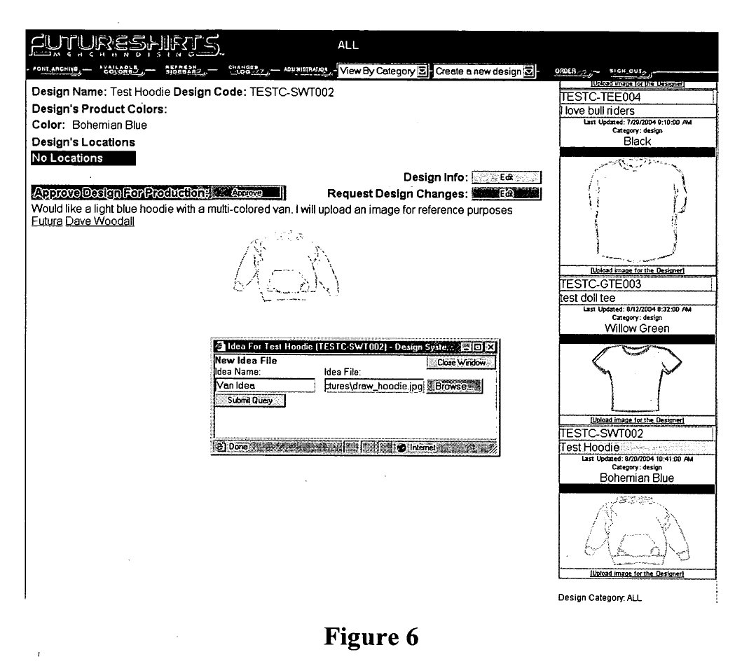

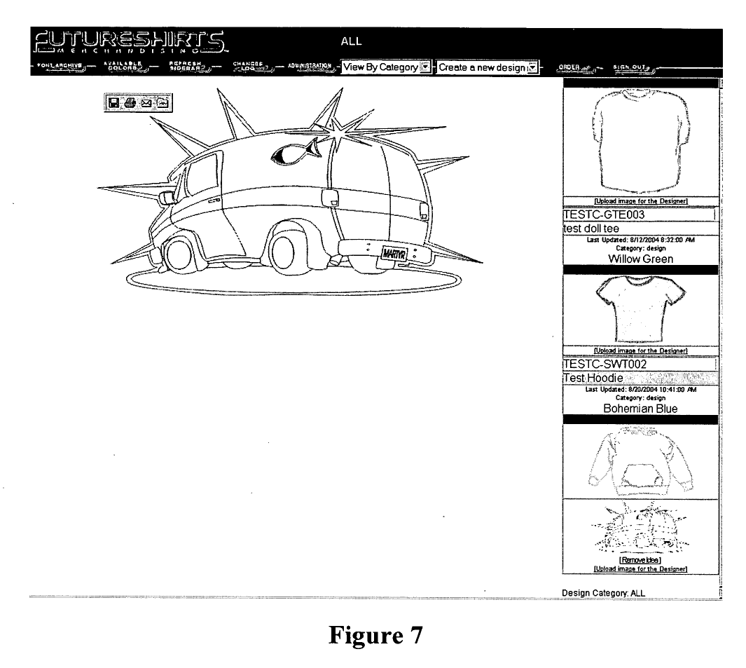

The system also allows the Product Developer to upload an image for the Graphic Artist to have a visual with the text description of the new product. The text description of the new product is input at the first stage of product creation by the Product Developer. It is generally a short name such as “American flag new tee.” For example, if the Product Developer wants the logo to emulate a drawing, the Product Developer can upload the drawing for the Graphic Artist to view along with the design request. FIG. 6 is a screen shot of the form for uploading an image for the Graphic Artist. FIG. 7 is a screen shot of the main design page after the image has been uploaded.

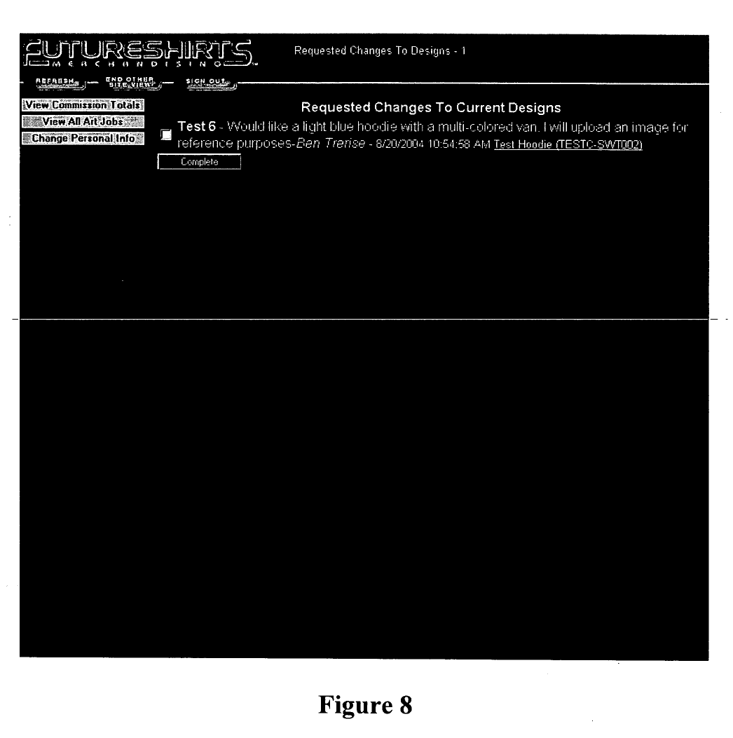

Each project is associated with one Graphic Artist. At the time of product creation, the Product Developer specifies which Graphic Artist he or she would like to complete the artwork. This is accomplished by selecting from a dropdown menu that lists all of the Graphic Artists in the system. The Company Administrator can add or remove Graphic Artists from the system. The design request appears on the Graphic Artist's home page, thereby notifying the Graphic Artist that he or she has a job to complete. The design request includes a priority designation for those products that are important to the Product Developer or his or her Client. FIG. 8 is a screen shot of the Graphic Artist's home page showing a design request. The design requests on the Graphic Artist's home page are automatically ordered by the system according to the priority designation and date of the request.

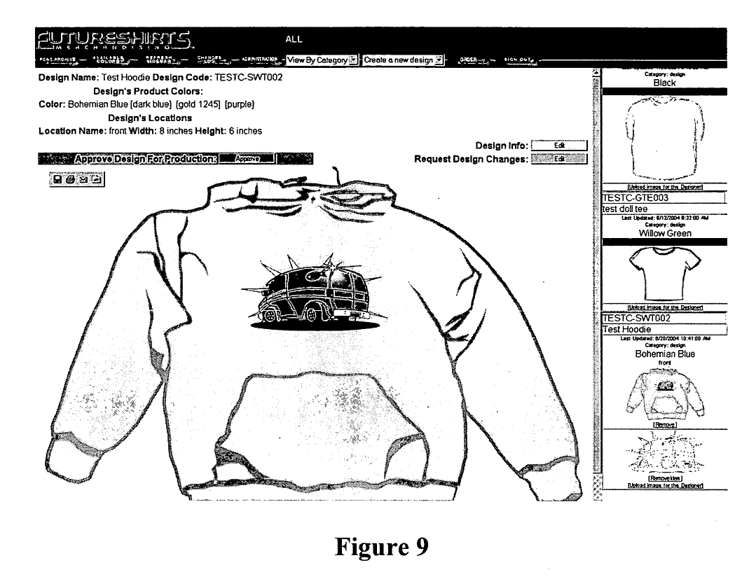

After the Graphic Artist completes a design request, he or she clicks a checkbox next to the design requests on his or her “to do” list (i.e., the list of design requests on the Graphic Artist's home page, as shown in FIG. 8). Typically, Graphic Artists and Standard Company Employees are the only users who have “to do” lists. The Graphic Artists' “to do” lists are generated automatically by the system and consist of uncompleted design requests. Once a design request is completed, the Product Developer receives an email indicating that the design request has been fulfilled. The Graphic Artist uploads a new image to replace the template that was created when the Product Developer selected a product type. FIG. 9 is a screen shot of the main design page after the Graphic Artist has uploaded the new image.

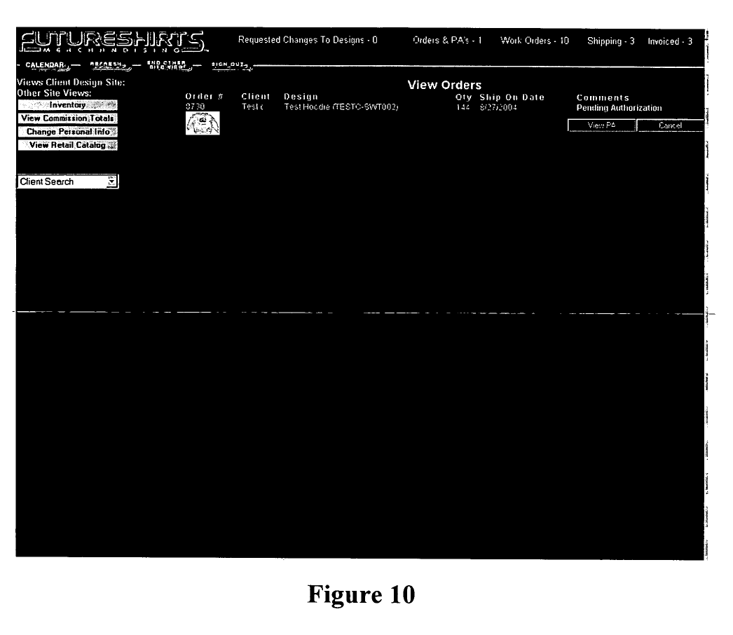

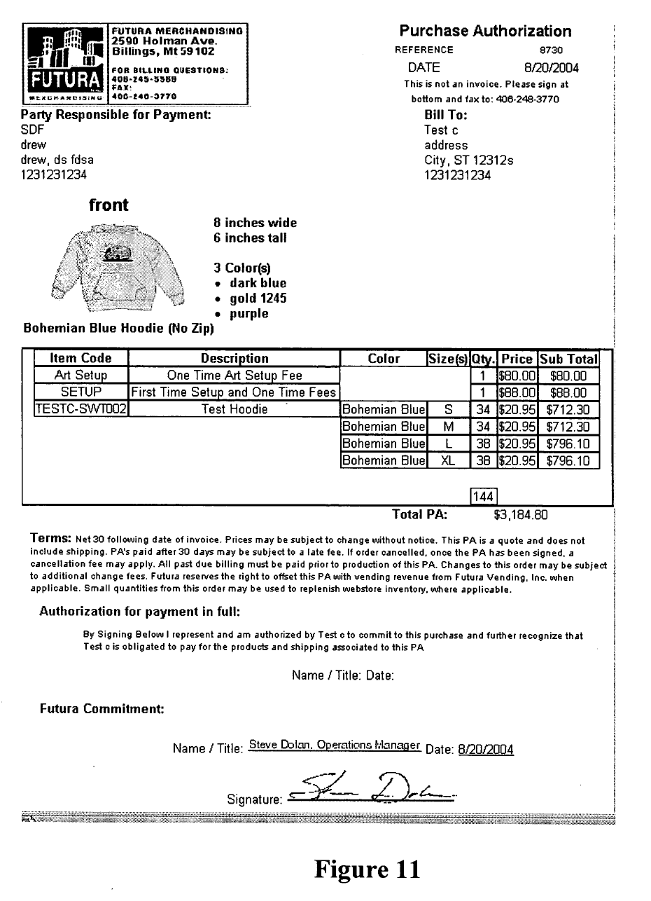

The new image includes the design completed by the Graphic Artist, and the system creates three separate image files for electronic documentation, approval and future reporting. These three image files are: thumbnail, mid-size, and full-size. The thumbnail image is used in the production subsystem and appears next to the product number on the quoting, purchase authorization and work order pages. FIG. 10 is a screen shot of a Product Developer's pending purchase authorization page, which includes a thumbnail image of the product. The mid-size image is used in all system reports, including the Supplier quote, the Manufacturer quote, the Company quote, the work order, the purchase order, the packing slip and the invoice. FIG. 11 is a screen shot of a purchase authorization page with a mid-size image of the product. The full-size image is available on the main design page and also by clicking on the mid-size or thumbnail image. A full-size image of the product is shown in FIG. 9.

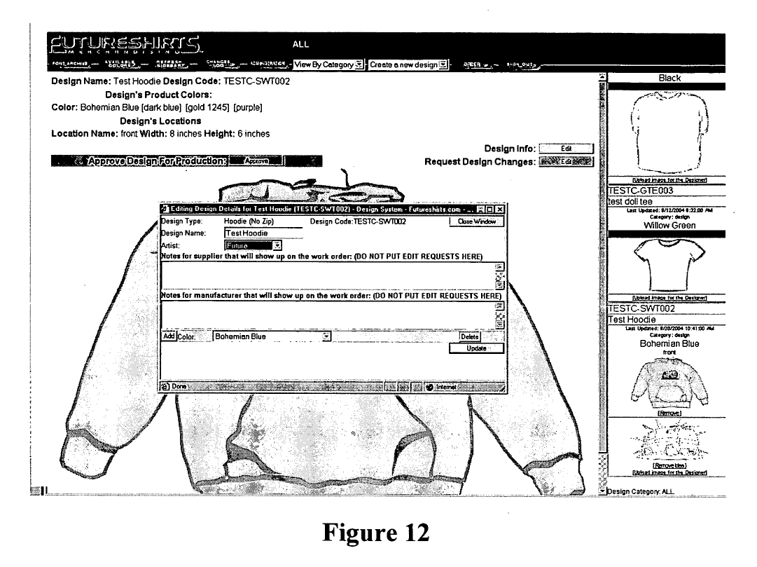

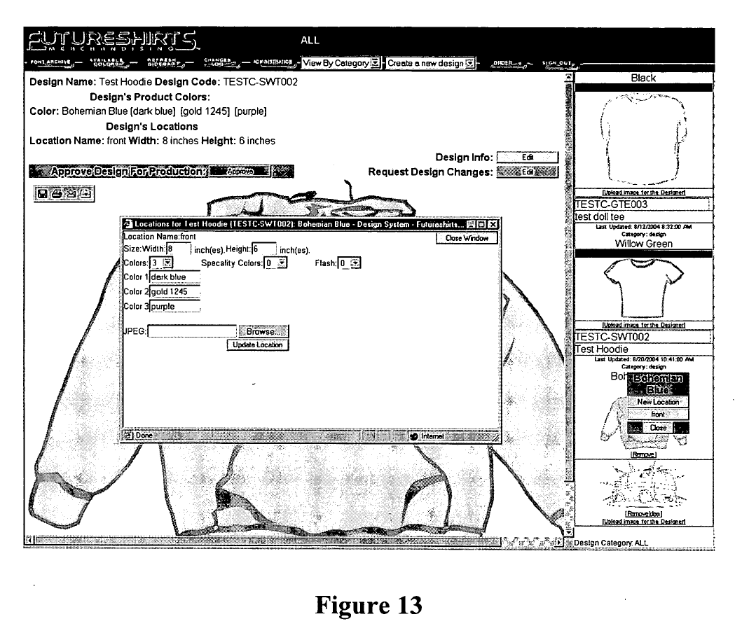

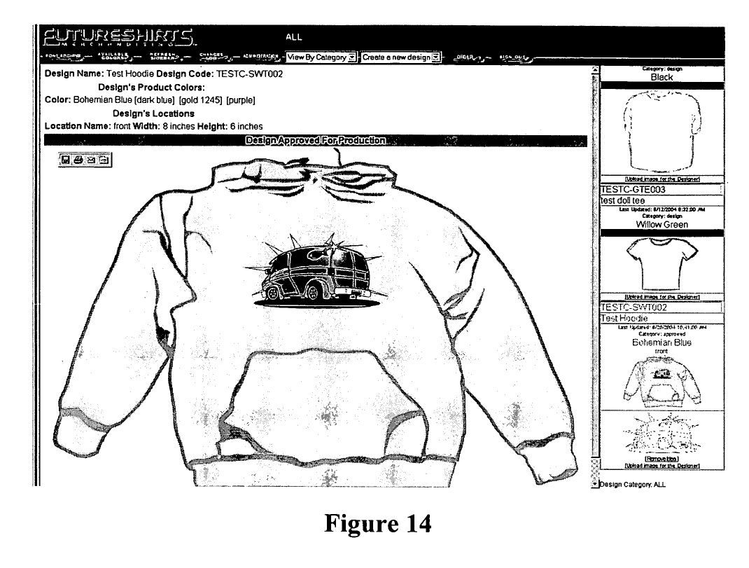

The Product Developer can request any number of design changes until he or she (or the Client whom the Product Developer represents) approves the design for production. Design changes are requested using the same form shown in FIG. 5. The Product Developer can edit the name of the product, the names of the product locations, and the color names and size specifications of the design image for each location. A product can have multiple locations. For example, a shirt can have a front, back and sleeve, each of which has different specifications and colors. FIG. 12 is a screen shot of the edit form for changing the product or location names. FIG. 13 is a screen shot of the edit form for changing the color names and size specifications for a design image on a particular product location. In the preferred embodiment, a design is approved for production by clicking a green “approve” button in the main frame of the design site on top of the full-size image of the design. FIG. 14 is a screen shot of the main design page after the product has been approved.

In an alternate embodiment, design changes can be requested via an interactive Flash movie. The purpose of this feature is to allow Product Developers to make certain changes to the product without having to involve the Graphic Artist. The movie is available after a Graphic Artist has uploaded the design image for a particular product template. The system inputs the design image into the interactive movie and displays the design image on the product template originally selected by the Product Developer. A Product Developer accesses the movie by clicking the mid-size image in the design site sidebar. After clicking the image, the movie will load in the main frame of the design site.

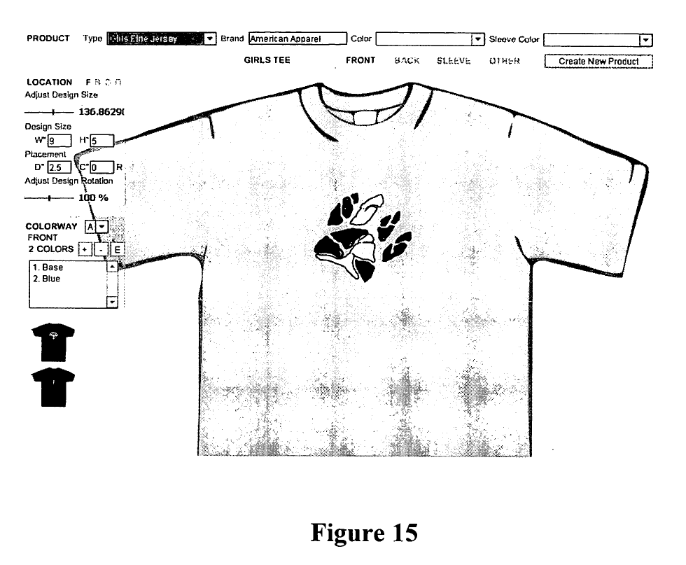

The interactive movie feature allows a Product Developer to move the design element to different locations on the product, change the design image size, change the product color(s), and change the product template (i.e., the product category). The design element is moved to a new location on the product by clicking and dragging the design element to a new location. The design element size is modified by moving a bar along a slide that increases or decreases the design element size. FIG. 15 is a screen shot of the interactive movie feature. The colors of the design image are not editable within the interactive movie feature because changes to the design element colors have to be communicated to the Graphic Artist. Once a product is approved, the movie feature is no longer available for that particular product.

The Product Developer ultimately has control over product creation, design requests and prioritization of design requests. The Graphic Artist is a resource that interacts with the system and uploads new electronic images of the product being produced. Once the design is approved, the product design cannot be changed by anyone but a Company Administrator.

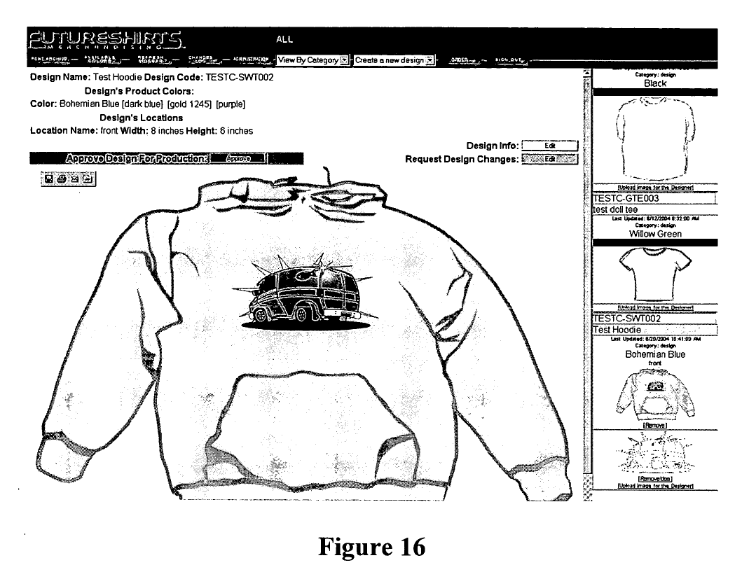

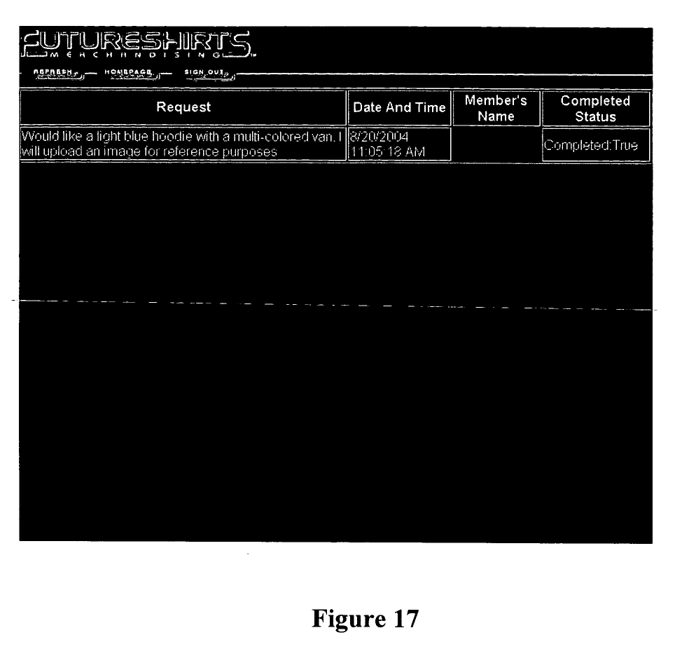

In the preferred embodiment, all of the products that have been created for a particular Product Developer or Client are shown in the order of creation on the main design page for those products in the design and approved categories (the product categories are described below). FIG. 16 is a screen shot of the main design page showing more than one product in the order of creation. The system also stores a list of all design edits placed in the system for reference purposes. This list is available from the main design page as a link on the top of the page. FIG. 17 is a screen shot of the logged design requests for a particular product. Anyone who has access to the design site also has access to the logged design requests.

The system also allows for viewing of products by their stage in the design process. The design stage categories are: design (i.e., products that still have design requests pending or that have not been officially approved), approved (products that have been approved by the Product Developer and/or Client), catalog (approved and previously ordered products that need no further design but will eventually need to be reordered), line (products from the design and catalog categories that are used to create a particular line for an event or other purpose), and deleted (products that have been discontinued). The system automatically categorizes products in the design, approved, catalog and deleted categories. Products are manually added to or removed from the line category by the Product Developer or Company Administrator.

At the end of the design process, the product has a design name that has been entered by the Product Developer, a unique design code that is automatically generated by the system upon creation of the product, and size specifications for the design element on each location of the product. Size specifications for the design elements are typically created by the Product Developer when the product is created. The product also has color information (as selected by the Product Developer) for each location on the product, source art file(s) (as uploaded by the Graphic Artist) and three associated picture sizes for display purposes (automatically created by the system). The product also has associated data relating to the method of production, which is specified during the design phase, and the design stage category.

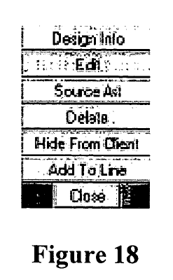

Many of the above features of the design site are accomplished through the use of a JavaScript-generated menu that is dynamically created when the Product Developer clicks the product name. FIG. 18 is a screen shot of this menu.

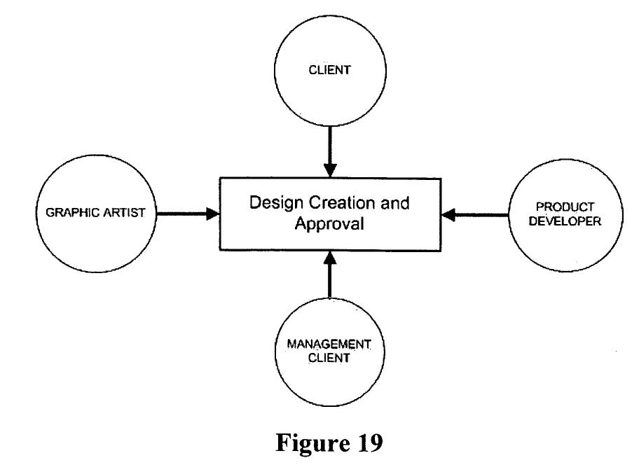

FIG. 19 is a diagram showing the various users that have access to the design creation and approval subsystem of the present invention.

IV. Ordering and Quotation Subsystem

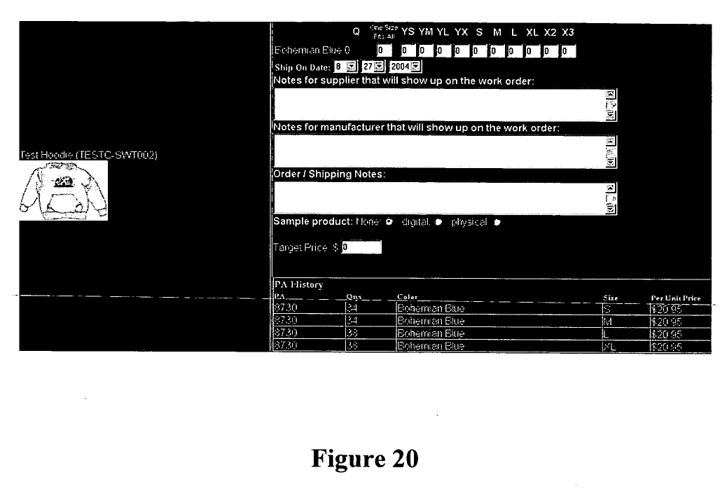

After a product has been approved, an order can be placed within the system. On the Product Developer's home page, an order can be placed for any of the Clients associated with the Product Developer. The order page lists only those products that have been approved, together with customized size boxes that correlate to the category and subcategory of the product created. The order page will indicate whether a particular product subcategory is available in certain sizes. The order page also has a purchase authorization history that lists all of the past orders of a particular product, as well as the quantities ordered and the per unit prices that were charged. FIG. 20 is a screen shot of the Product Developer's order page for a particular product.

After the quantities have been input into the size boxes and the order button is clicked, the order is created. Upon creation of the order, emails are sent to the Company Administrator(s), the Product Developer and the Client and a posting is made to their respective home pages informing them of the creation of the order.

After the order is placed, the order shows up on the Company “Requested Orders” page, where a Company Administrator can select the Supplier(s) and Manufacturer(s) from whom to solicit quotes. In most instances, the Company will usually select a Supplier of raw goods and a Manufacturer who will manufacture the final product. In some instances, however, a single company may act as both the Supplier and Manufacturer.

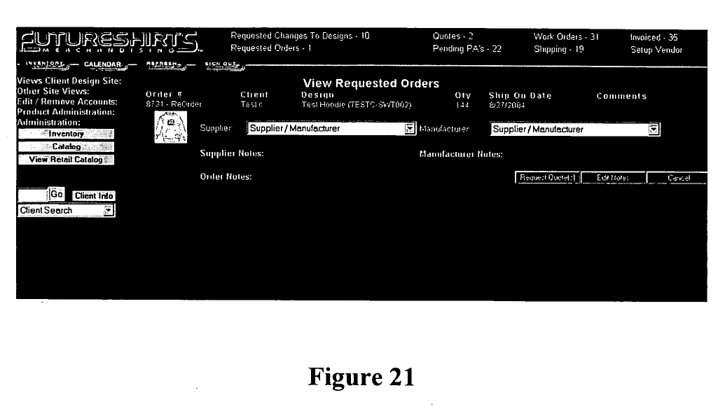

If the order is a reorder of a particular product, the last Supplier and Manufacturer (or Supplier/Manufacturer if the Supplier and Manufacturer were the same entity) that produced the goods will automatically be selected, giving the Company Administrator the ability to request quotes quickly. FIG. 21 is a screen shot of the Company Administrator “Requested Orders” page showing a reorder of a particular product.

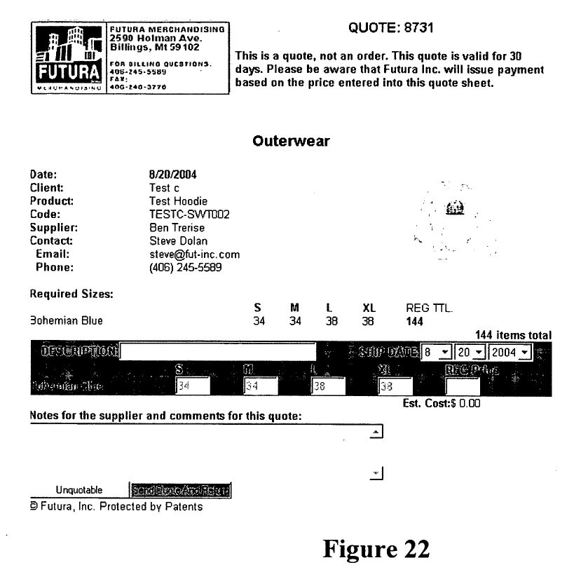

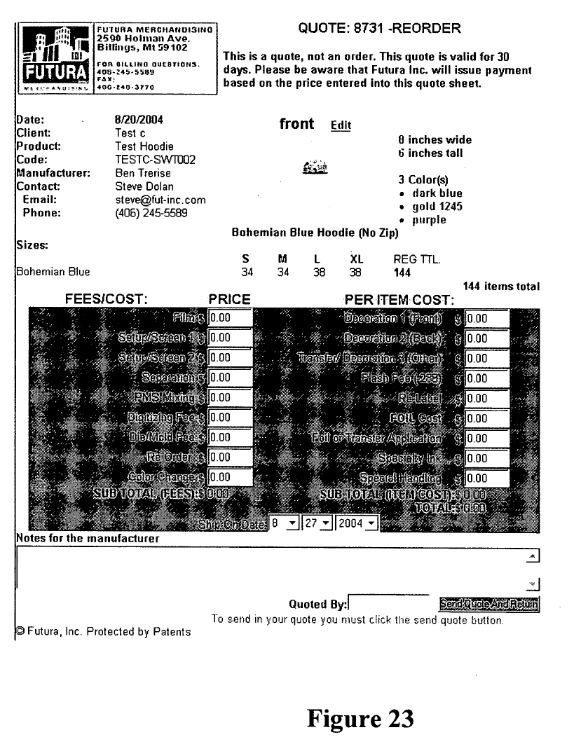

Multiple Suppliers and Manufacturers can submit quotes for any particular order. The Company can request multiple quotes from many different Suppliers and/or Manufacturers and compare such quotes by price and/or availability. The selected Supplier(s) and/or Manufacturer(s) receive emails informing them of the request for a quote and providing instructions on how to log in to the system and fill out the quote form. FIG. 22 is a screen shot of a blank Supplier quote form. FIG. 23 is a screen shot of a blank Manufacturer quote form. The method of production selected previously in the design stage is indicated on the Manufacturer quote form in the design description and the notes for that order. The purpose of that information is to enable the Manufacturer to take that information into account in providing its quote.

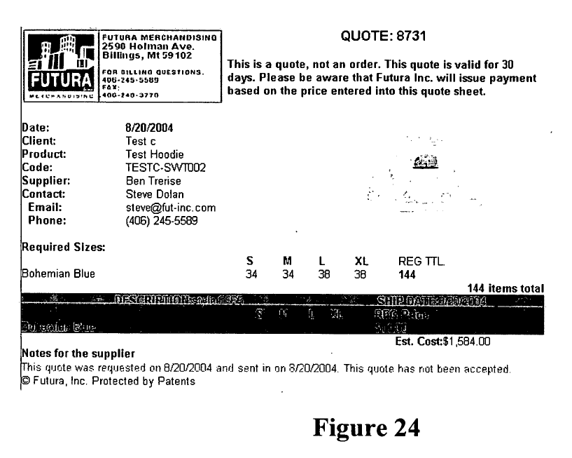

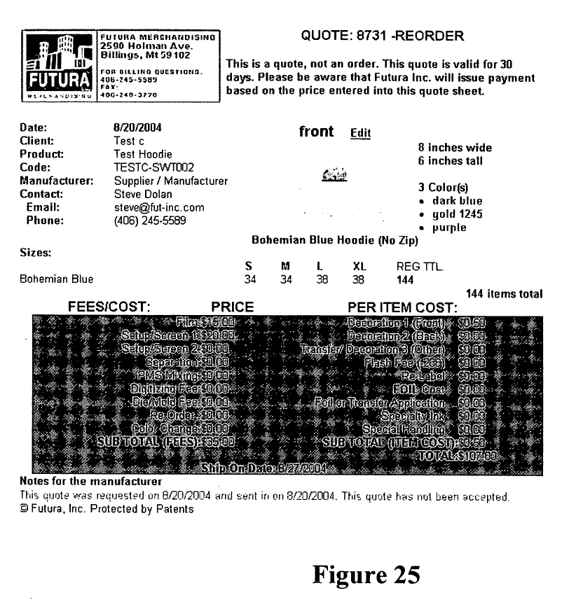

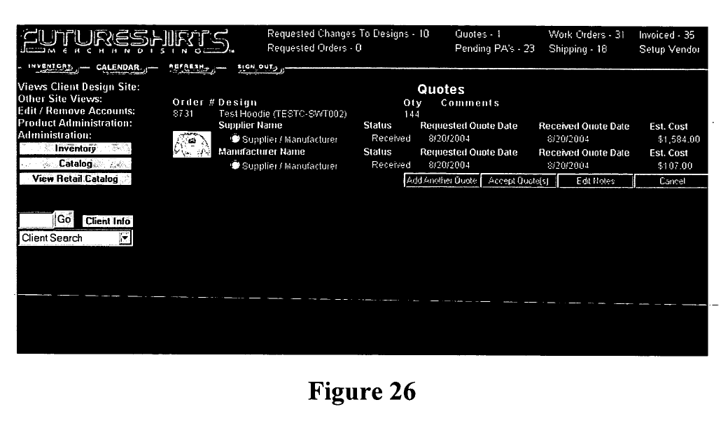

When quotes are submitted by the Supplier(s) and Manufacturer(s), emails are sent to the Company Administrator(s). FIG. 24 is a screen shot of a completed Supplier quote. FIG. 25 is a screen shot of a completed Manufacturer quote. Once quotes are received, a Company Administrator accepts one Supplier quote and one Manufacturer quote. If a Supplier will also be undertaking the manufacturing of the product, then only one quote from a Supplier/Manufacturer is accepted. FIG. 26 is a screen shot of the Company Administrator “Quotes” page showing the quotes received from the Supplier(s) and Manufacturer(s) and the radio buttons for acceptance of the Supplier and Manufacturer quotes.

As the final step in the quoting stage, a Company Administrator completes the Company quote. This aspect of the system has many automated features, including a table setting forth the markup percentages for each Client based on values that have been entered previously by a Company Administrator. Markup percentages differ based on quantity and order history with the Company. The system automatically applies a default markup percentage for the particular Client to each quote received.

At the quote page, the system will also determine whether a commission needs to be added for the Graphic Artist and automatically apply his or her commission to the quote form. Commissions are typically based on verbal or written agreements between the Graphic Artist and the Company and are entered into the Graphic Artist's account information by a Company Administrator.

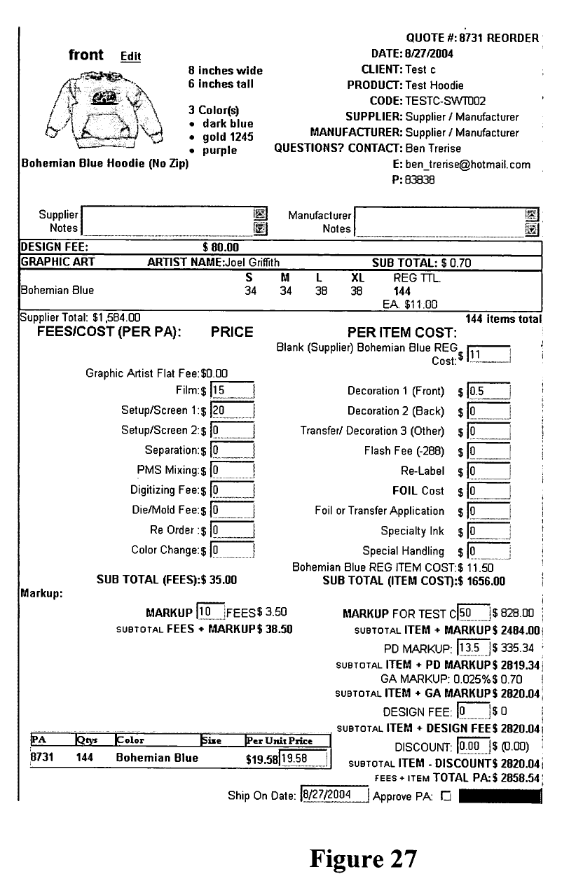

To generate the Company quote, the system will automatically fill in the prices that have been accepted from the Supplier and Manufacturer, the markup percentages for that particular Client, the Graphic Artist's commission, and the Product Developer's commission, if applicable. A Product Developer's commission is typically entered into the system by a Company Administrator upon creation of an account for the Product Developer. FIG. 27 is a screen shot of the Company quote form as filled out by the system before Company Administrator review.

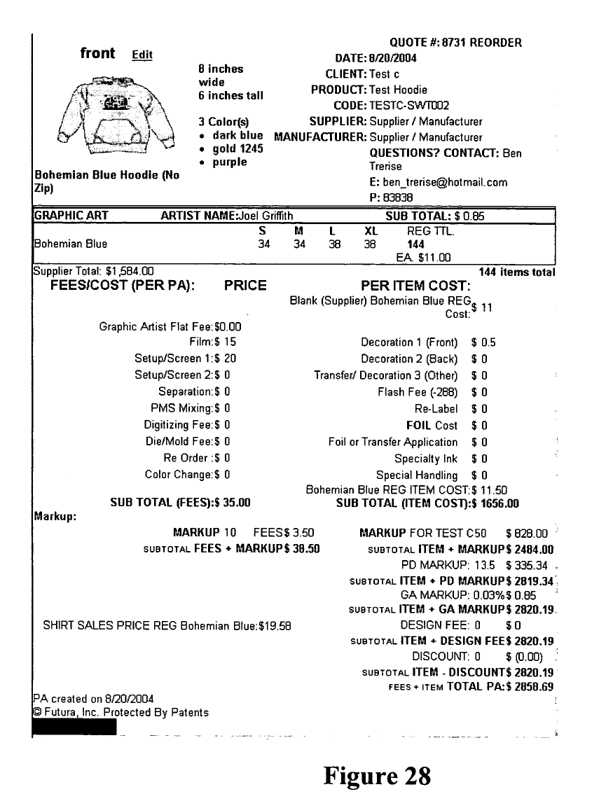

A Company Administrator may review the number and click “accept” or change the numbers (including the markup percentages and commissions for this particular order) before accepting the Company quote. FIG. 28 is a screen shot of a completed Company quote. The automated JavaScript-enabled quote page automatically updates subtotals and per unit prices when markup percentages or prices are changed on the form.

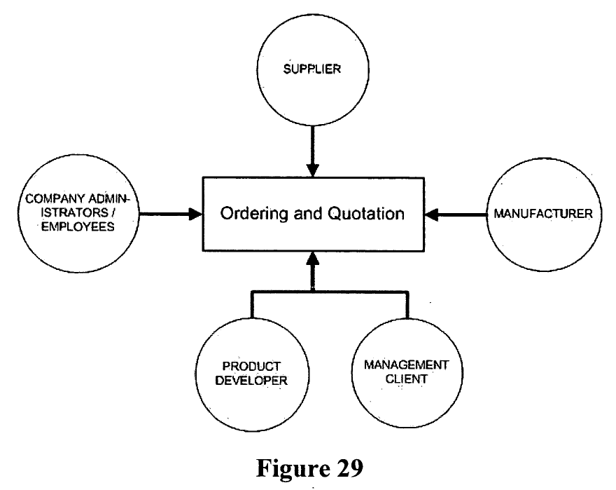

FIG. 29 is a diagram showing the various users that have access to the ordering and quotation subsystem of the present invention.

V. Purchase Authorization Subsystem

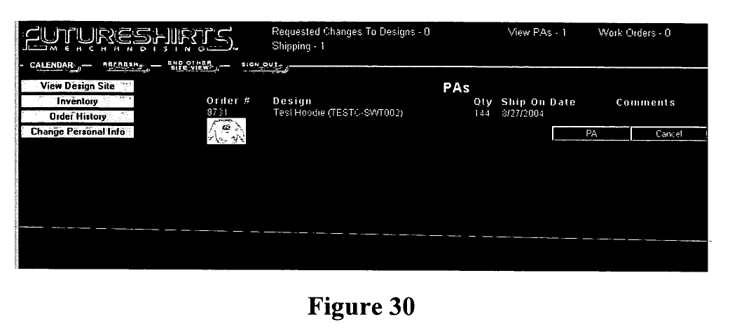

Once the Company quote is completed, the system creates a purchase authorization, and an email is sent to the Client and the Product Developer requesting approval or rejection of the purchase authorization. The purchase authorization shows up on the Client's “View PA's” page. FIG. 30 is a screen shot of a pending purchase authorization from a client's “View PA's” page.

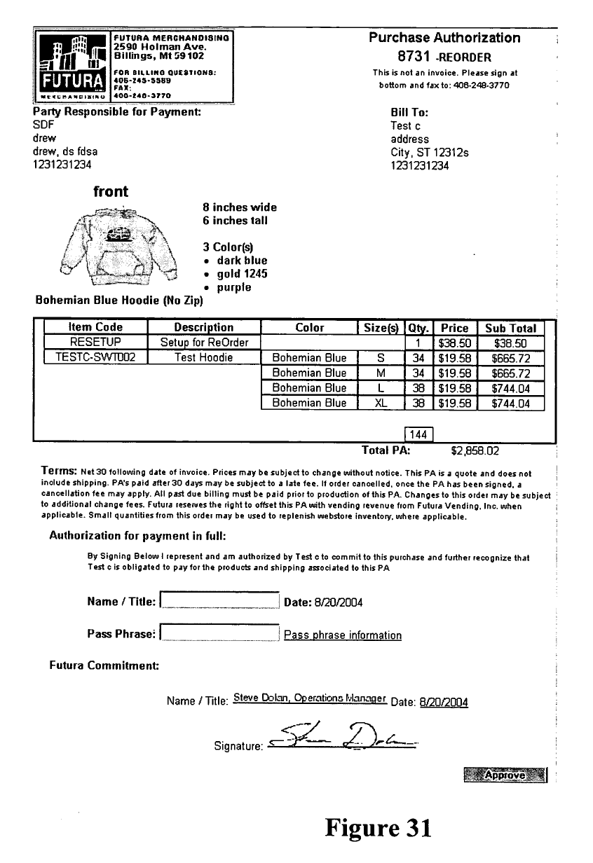

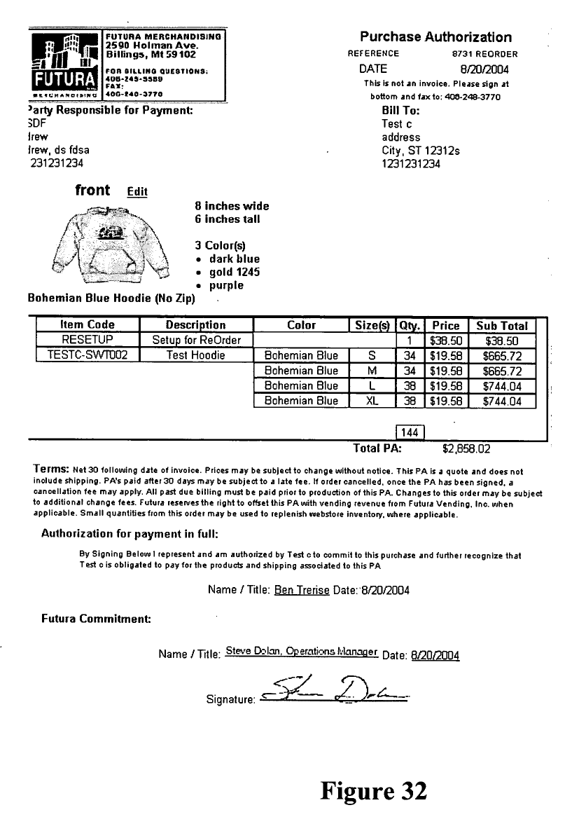

A pending purchase authorization can be approved online by the Client or a Company Administrator. Approval by the Client is accomplished by an embedded form in the purchase authorization report that requires a pass phrase that is different than the Client's password. FIG. 31 is a screen shot of a purchase authorization report before it has been accepted. FIG. 32 is a screen shot of a purchase authorization report after it has been accepted. When a purchase authorization is accepted and enters into the production phase, the Product Developer and Company Administrator(s) receive an email, and the Supplier and Manufacturer receive appropriate documentation, namely, a purchase order for the Supplier and a work order for the Manufacturer.

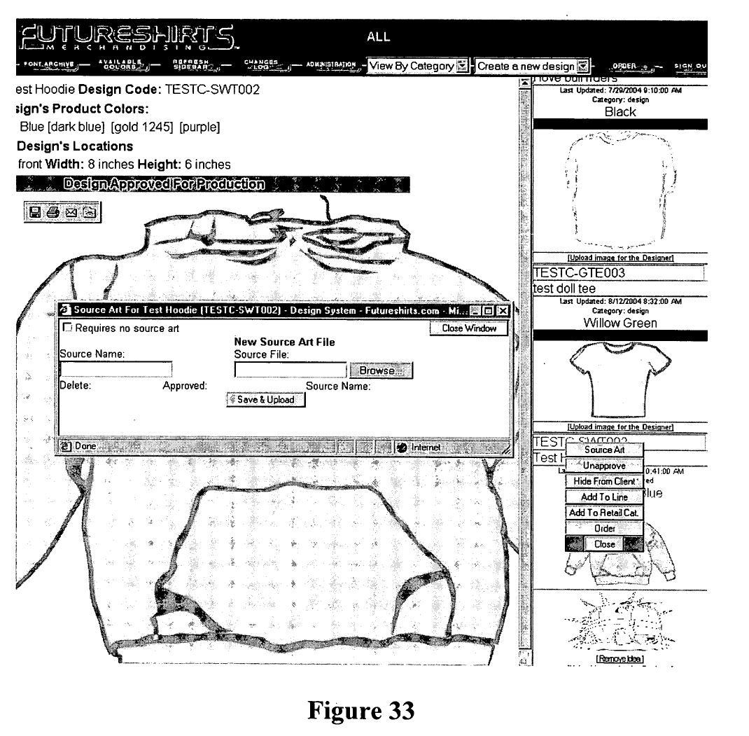

After a purchase authorization is approved, source art files for the design image are uploaded by the Graphic Artists. The source art files are large image files typically stored in compressed formats such as “zip” or “sit” that the Manufacturer uses to produce the product. For example, the source art files for a t-shirt design could be compressed and sent to a screen printer to be transformed into the screens for the actual production of the shirts. The source art files are available through a link on the work order. FIG. 33 is a screen shot of the form for uploading source art files for the Manufacturer.

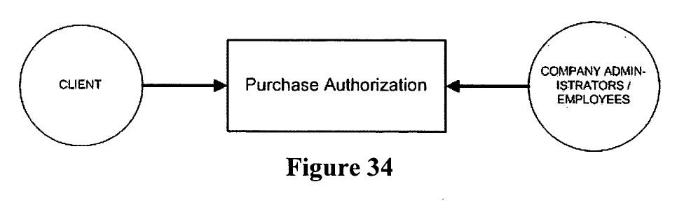

FIG. 34 is a diagram showing the various users that have access to the purchase authorization subsystem of the present invention.

VI. Work Orders and Production Subsystem

An approved purchase authorization moves to the work order stage, where email confirmations are sent to the accepted Supplier and Manufacturer informing them that the job has been approved for production. A notation is added to the Graphic Artist page asking the Graphic Artist to prepare the final version of the artwork to send to the Supplier.

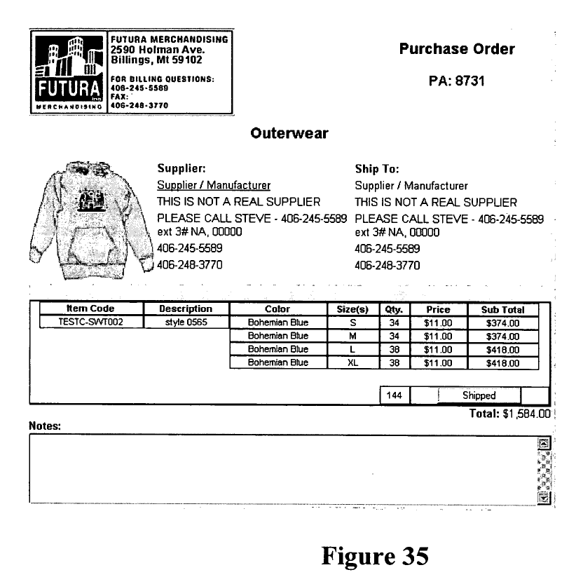

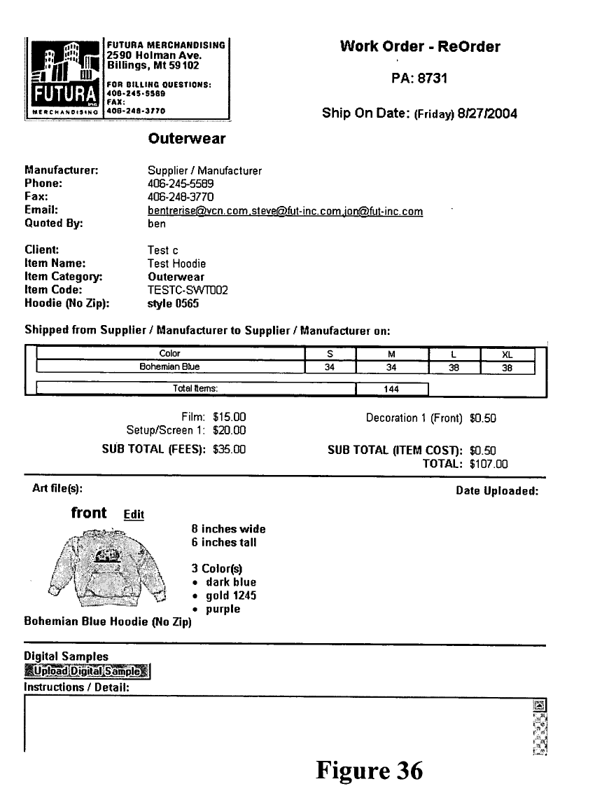

The system issues a purchase order to the Supplier and a work order to the Manufacturer. The purchase and work orders are made available on their respective home pages of the Supplier and Manufacturer simultaneous with a Client's approval of a purchase authorization online. This feature allows purchase and work orders to be sent and received outside of normal business hours. FIG. 35 is a screen shot of a purchase order. FIG. 36 is a screen shot of a work order.

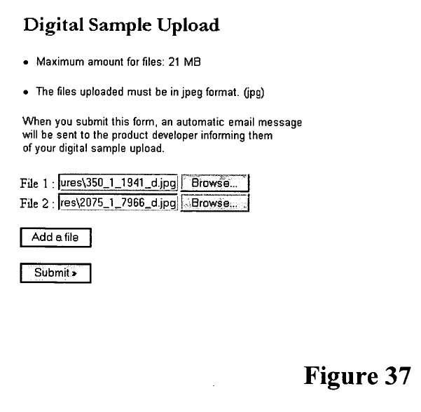

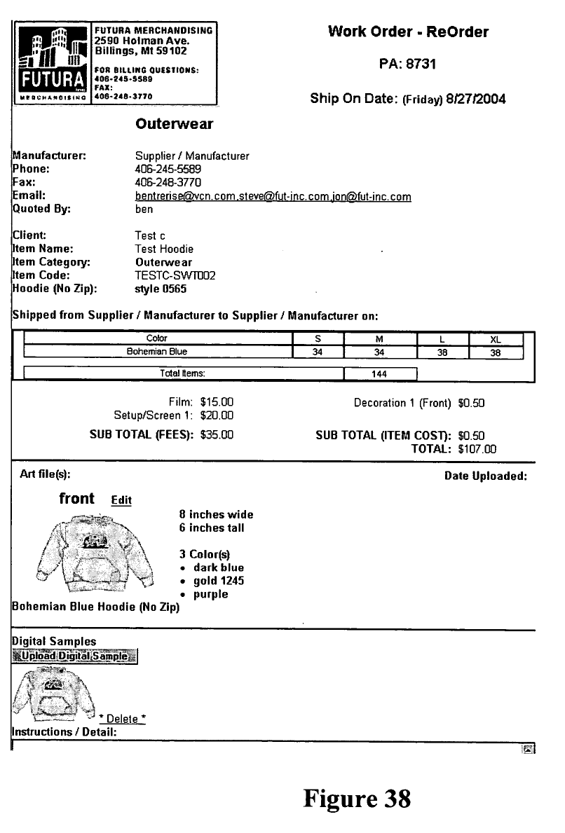

The work order allows the Manufacturer to upload a digital image of a product sample so that the Product Developer can approve it before the Manufacturer proceeds to full production. FIG. 37 is a screen shot of the form for uploading the digital image of the product. This feature provides yet another opportunity to avoid mistakes or miscommunications before full-scale production. FIG. 38 is a screen shot of the work order with the uploaded digital image of the actual product.

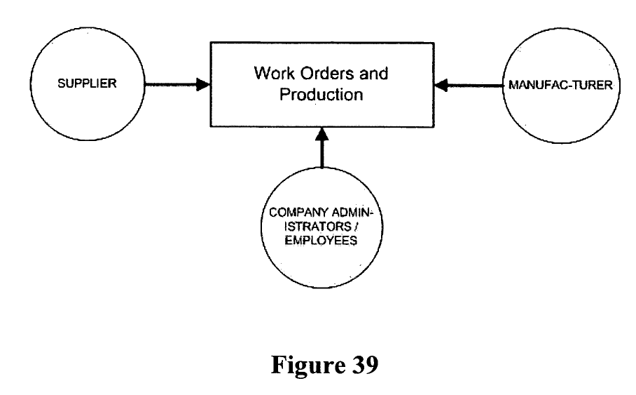

FIG. 39 is a diagram showing the various users that have access to the work orders and production subsystem of the present invention.

VII. Shipping Subsystem

When production is complete and the Manufacturer has notified the Company of the completion of production either by telephone or email, shipping information is input into the system by a Standard Company Employee or Company Administrator, and a packing slip is physically attached to or placed inside the boxes that are shipped. When the Manufacturer prints out the packing slip, information relating to that order is moved to the shipping stage.

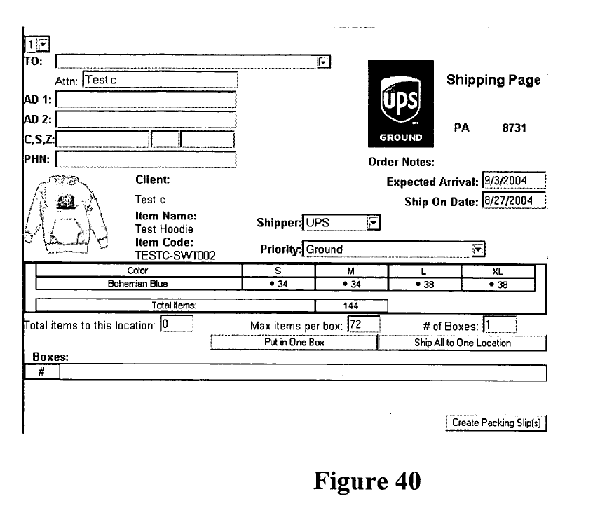

FIG. 40 is a screen shot of a blank packing slip with the default settings for shipper designation and expected arrival date. The packing slip requires an address to be entered, which happens automatically when the user selects an address from a dropdown menu. Next, either a Company Administrator or a Standard Company Employee enters the shipper (e.g., UPS, Federal Express, etc.) and the priority mail designation. Those two selections (shipper and priority) automatically cause the ship image and expected arrival date to change from pre-selected default settings (or not, if the default settings are appropriate). The ship image represents the selected shipping option. The expected arrival date is displayed on the packing slip.

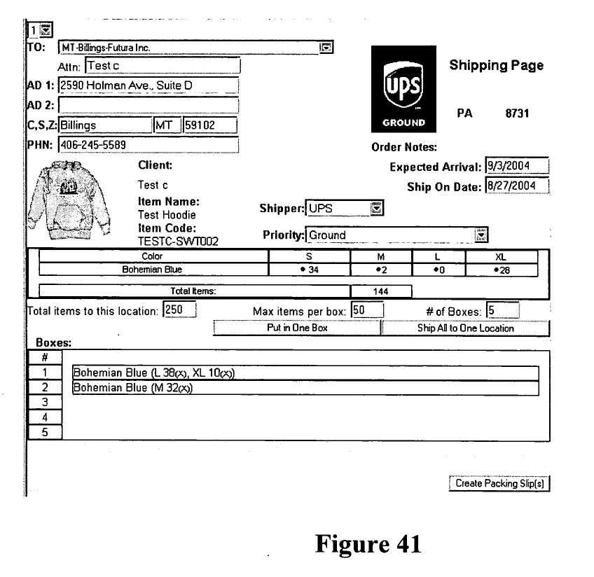

The user next enters the number of items to be shipped per box. This task is accomplished by using a unique click-and-drag application that allows the user to drag the sizes and quantities into the created boxes. Boxes are typically created by inputting the number of items that will fit into a box. The system takes the total quantity of the order, divides the total quantity by the number of products that will fit into each box, and creates the appropriate number of boxes for the click-and-drag procedure. The click-and-drag procedure allows the user to organize the boxes by size. FIG. 41 is a screen shot showing five created boxes, two of which have been filled using the click-and-drag procedure.

The packing slip allows for multiple ship locations. It also has two buttons that perform specific tasks. The first button automatically puts all of the items into one box. The second button calculates how many boxes will be needed based on the quantity and the number of items that will fit in a box (as input by the user) and separates the items into these newly created boxes.

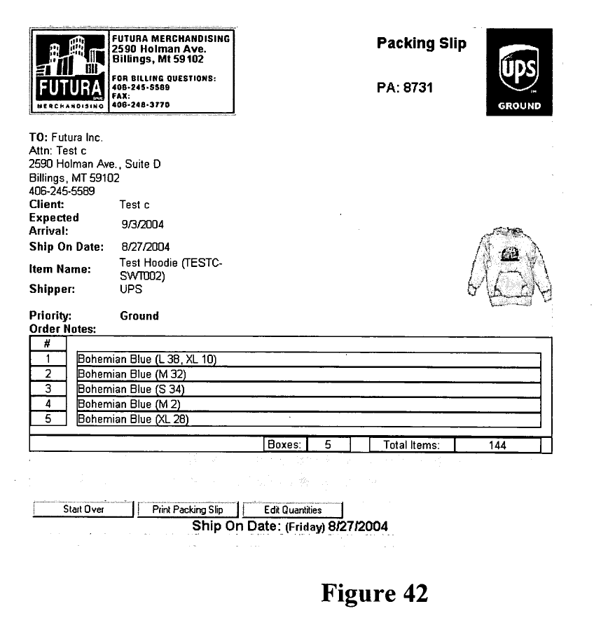

Once the packing slip is created, emails are generated and sent to the Company Administrator(s), the Client, the Product Developer, and those individuals receiving the shipment(s) (which could be a Client office, warehouse or event location), to inform them that the shipment is on its way. The final step in the shipping process is for the tracking information and shipping price to entered into the system by a Company Administrator or Standard Company Employee. FIG. 42 is a screen shot of a completed packing slip.

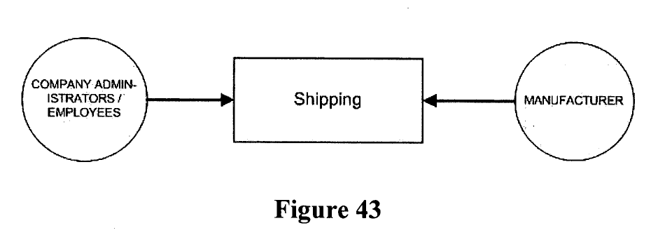

FIG. 43 is a diagram showing the various users that have access to the shipping subsystem of the present invention.

VIII. Invoicing Subsystem

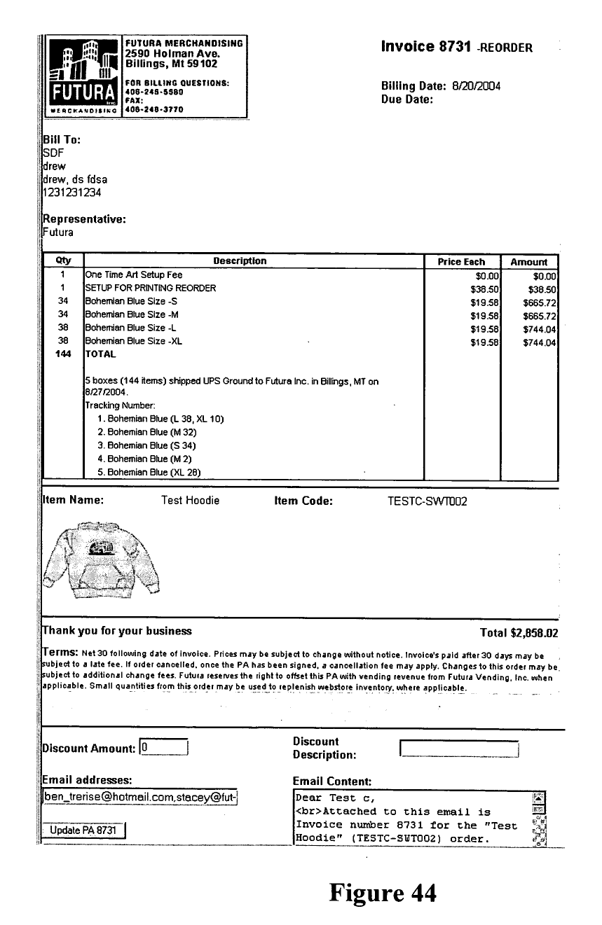

After the tracking and shipping price have been entered into the system, the order is ready to be invoiced. A discount can be applied by a Company Administrator at this time before the invoice is electronically sent. The content of the email that is transmitted with the invoice can also be edited on the invoicing page. FIG. 44 is a screen shot of an invoice before it is billed to the Client, including the email content form.

Once the user is satisfied with the email content, the “complete PA” button is clicked, which accomplishes a number of things. First, a Portable Document Format (PDF) file is created using the invoice web page as the imported data. Second, an email is created using the email content and addresses from the invoice, and the PDF invoice file is attached to the email. This email is sent to the Client, the Company Administrator(s) and, optionally, the Product Developer. The invoice includes tracking information, which can be clicked on to check on package arrival from either UPS or Federal Express. The completed invoice looks identical to FIG. 44 without the email content form.

The PDF invoice file is saved on the Company server, providing a “point in time” reference that cannot be dynamically changed with database entry. The order number is moved from the shipping stage to an “Invoiced” category within the system, where it waits to be input into QuickBooks or another accounting program. This process invoices the Client electronically before the information is even recorded into Company accounting records.

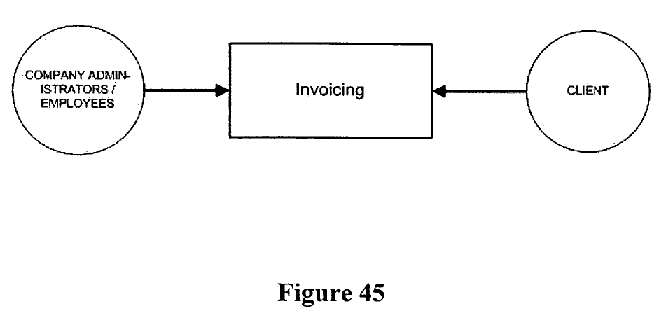

FIG. 45 is a diagram showing the various users that have access to the invoicing subsystem of the present invention.

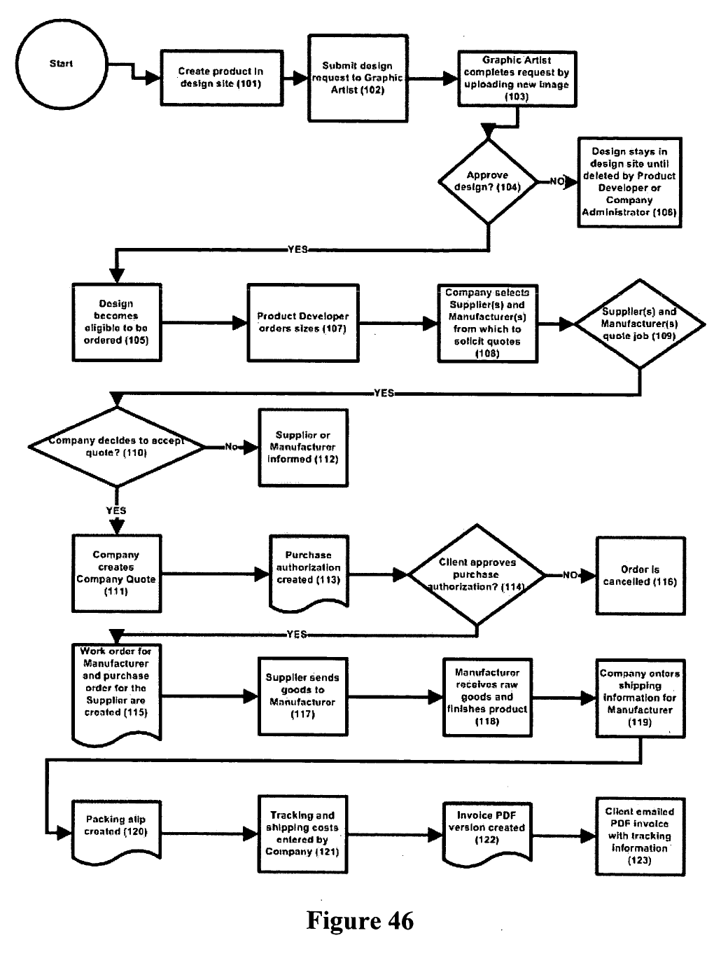

FIG. 46 is an overview of the workflow of the entire system as described above. First, a product is created in the design site 101. Next, a design request is submitted 102. The Graphic Artists completes the design work and uploads the new image 103. If the design is approved 104, then it becomes eligible to be ordered 105. If the design is not approved 104, then it remains in the design site until deleted by the Product Developer or Company Administrator 106.

To complete the order, the Product Developer selects the sizes 107. The Company then selects the Supplier(s) and Manufacturer(s) from which to solicit quotes 108. The Supplier(s) and Manufacturer(s) submit quotes 109, and if a quote is accepted 110, then the Company creates a Company quote 111. If a quote is not accepted 110, then the Supplier(s) or Manufacturer(s) is/are informed 112.

After the Company quote is created 111, the system generates a purchase authorization 113. To create a Company quote, a purchase authorization is created 113. If the Client approves the purchase authorization 114, then a work order for the Manufacturer and a purchase order for the Supplier are created 115. If the Client does not approve the purchase authorization 114, then the order is cancelled 116.

If the purchase authorization was approved, then the Supplier sends the raw goods to the Manufacturer 117, and the Manufacturer receives the raw goods and finishes the product 118. The Company enters shipping information into the system 119, the system generates a packing slip 120, and tracking and shipping costs are entered by a Company Administrator or Standard Company Employee 121. The system generates a PDF version of the invoice 122, which is emailed to the Client along with tracking information 123.

IX. Calendaring Features

In addition to the features described above, the system of the present invention includes a number of calendaring features. These calendaring features are particularly useful as a management planning tool for the Company. Depending on the user's profile, the system selectively displays the information included in the calendar. A Client would only see information relating to its order(s), a Product Developer would only see the order(s) for which he or she is responsible, and a Supplier or Manufacturer would only see those jobs that pertain to it. A Company Administrator can limit the particular jobs displayed on the calendar to only those jobs assigned to a particular Product Developer, Client, Supplier or Manufacturer-or the Company Administrator can view all jobs in production.

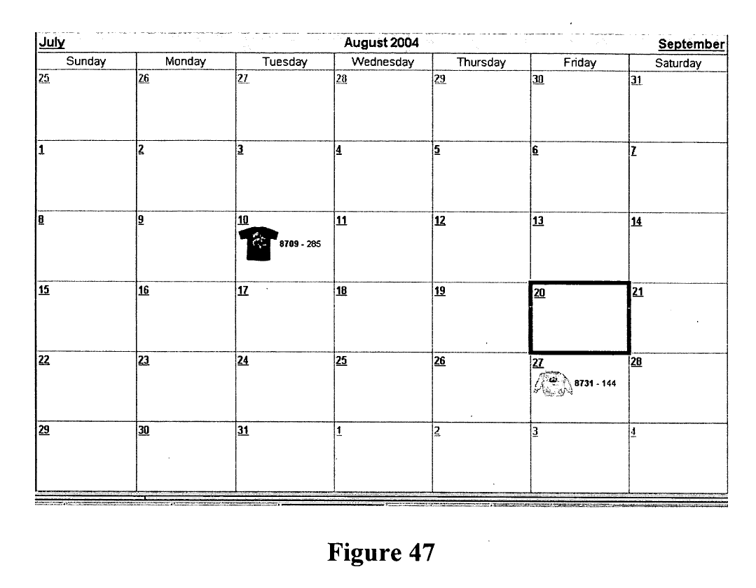

The calendaring features are available on a calendar that automatically pops off the home page when a user logs in. There is also a link to the calendar on each user's home page. When a purchase authorization is created, the purchase authorization is displayed on the calendar on the estimated ship date. The purchase authorization entry includes the following information: order number, quantity, Manufacturer and a thumbnail image of the product. When a purchase authorization is approved, the purchase authorization entry is displayed in bold. If the actual ship date differs from the estimated ship date, then the purchase authorization entry will move to the actual ship date. FIG. 47 is a screen shot of the calendar from the Client's perspective showing a purchase authorization entry that has been approved. When an order is shipped, the purchase authorization entry changes color to signify that the order has shipped. When an invoice is completed for a particular order, that order disappears from the calendar altogether.

The calendar entries can be edited by a Company Administrator or anyone else who has access to the calendar. If a purchase authorization entry is moved to a different ship date within the calendar, the system will automatically update the ship date for that order throughout the system. Conversely, if a ship date changes within the system, the purchase authorization entry is automatically moved to the new ship date within the calendar, and the user is alerted to the change the next time he or she logs into the system or accesses the calendar. A Manufacturer can use the calendar to prioritize jobs assigned to the same ship date by assigning a time of day to each job. The calendar also includes a box where comments can be added regarding a particular order.

The system of the present invention can be used in connection with any physical product that has a design element. The system provides all of the necessary tools for requesting a product, designing the product, and coordinating the production and shipping of the product to the customer. The system is not limited in terms of the number of product types, colors, product categories, methods of production, or number of entities in each profile.

The product examples provided in this specification are for illustrative purposes only and are not to be interpreted as limiting the scope of the present invention. Similarly, the screen shots are provided by way of example and are not intended to be limiting in terms of the precise layout of the screen shots or the data reflected in the screen shots. Rather, the screen shots are provided to help the reader better understand the functionality encompassed by the present invention. Definitions relating to user groups (Company Administrator, Product Developer, etc.) are intended to encompass those individuals who act in the capacities described for those user groups and are not intended to limit the present invention to the particular terms used to describe those user groups.

The many features and advantages of the present invention are apparent from the detailed specification, and the appended claims are intended to cover all such features and advantages. Because numerous modifications will readily occur to those skilled in the art, the present invention is not limited to the exact construction and operation illustrated and described herein, but rather encompasses all such modifications and equivalents.

We claim:

1. A system for automated product design and approval comprising: a design creation and approval subsystem, an ordering and quotation subsystem, a purchase authorization subsystem, a work orders and production subsystem, a shipping subsystem and an invoicing subsystem.

2. The system for automated product design and approval of claim 1, wherein the design creation and approval subsystem comprises a main design page with product categories and subcategories, product colors, and methods of production, wherein the product categories and subcategories can be modified by a Company Administrator,
wherein the product colors can be added to, removed or modified by a Company Administrator,
wherein the methods of production can be added to, removed or modified by a Company Administrator,
wherein a product template is created by selecting the product category and subcategory from a dropdown menu, and
wherein a design request is input into a design request form that is embedded within the main design page.

3. The system for automated product design and approval of claim 2, wherein product color(s) and size specifications are selected by a Product Developer when the product template is created.

4. The system for automated product design and approval of claim 2, wherein a product name is entered by a Product Developer when the product category and subcategory are selected.

5. The system for automated product design and approval of claim 2, wherein the system generates a unique design code for each product.

6. The system for automated product design and approval of claim 2, wherein the design request includes an image that is uploaded by the person submitting the design request.

7. The system for automated product design and approval of claim 2, wherein a Graphic Artist is selected from a dropdown menu, and wherein the design request appears on the Graphic Artist's home page.

8. The system for automated product design and approval of claim 7, wherein the design request includes a priority designation, and
wherein the design requests on the Graphic Artist's home page are automatically ordered by the system according to the priority designation and date of the request.

9. The system for automated product design and approval of claim 8, wherein the Graphic Artist clicks a checkbox next to the design request on his or her home page after completing the design request,
wherein the design request is entered by a Product Developer,
wherein the Product Developer receives an email indicating that the design request has been fulfilled, and
wherein the Graphic Artist uploads a new product image with a design element to replace the product template that was created upon selection of the product category.

10. The system for automated product design and approval of claim 9, wherein the system creates three separate image files for the product image, and
wherein the three separate image files are a thumbnail image, a mid-size image, and a full-size image.

11. The system for automated product design and approval of claim 10, wherein the system further comprises quoting, purchase authorization and work order pages, and
wherein the thumbnail image appears on the quoting, purchase authorization and work order pages,
wherein the system generates a Supplier quote, a Manufacturer quote, a Company quote, a work order, a purchase order, a packing slip, and an invoice, and wherein the mid-size image appears on the Supplier quote, the Manufacturer quote, the Company quote, the work order, the purchase order, the packing slip, and the invoice, and
wherein the full-size image is available on the main design page and also by clicking on the mid-size or thumbnail image.

12. The system for automated product design and approval of claim 9, wherein the Product Developer can request design changes using the design request form.

13. The system for automated product design and approval of claim 9, wherein the Product Developer can request design changes using an interactive Flash movie feature.

14. The system for automated product design and approval of claim 13, wherein the Product Developer can change the location of the design element by clicking and dragging the design element to a new location on the product.

15. The system for automated product design and approval of claim 14, wherein the Product Developer can change the size of the design element by moving a bar along a slide that increases or decreases the design element size.

16. The system for automated product design and approval of claim 9, wherein the product is approved by the Product Developer by clicking a button on the main design page.

17. The system for automated product design and approval of claim 16, wherein the system automatically categorizes products according to their design stage categories,
wherein the design stage categories include design, approved, catalog, line and deleted,
wherein the system automatically categorizes products in the design, approved, catalog and deleted categories, and
wherein products are manually added to or removed from the line category by a Product Developer or Company Administrator.

18. The system for automated product design and approval of claim 9, wherein all of the products that have been created for a particular Product Developer are shown in the order of creation on the main design page.

19. The system for automated product design and approval of claim 12, wherein the system stores a list of all design changes, and
wherein the list of design changes is accessible from a link on the main design page.

20. The system for automated product design and approval of claim 1, wherein the ordering and quotation subsystem comprises an order page,
wherein the order page comprises a list of products that have been approved,
wherein the order page further comprises size boxes that correlate to the category and subcategory of the product,
wherein the order page indicates whether a particular product subcategory is available in certain sizes, and
wherein the order page further comprises a purchase authorization history.

21. The system for automated product design and approval of claim 20, wherein an order is created by entering quantities into the size boxes and clicking the order button.

22. The system for automated product design and approval of claim 20, wherein the system sends emails to one or more Company Administrator(s), a Product Developer and a Client when an order is created.

23. The system for automated product design and approval of claim 20, wherein the system further comprises home pages for one or more Company Administrator(s), a Product Developer, and a Client, and
wherein a posting is made to the home pages of the Company Administrator(s), Product Developer and Client when an order is created.

24. The system for automated product design and approval of claim 21, wherein the order appears on a Company “Requested Orders” page, and
wherein a Company Administrator selects one or more Supplier(s) and Manufacturer(s) from whom to solicit quotes.

25. The system for automated product design and approval of claim 24, wherein the order is a reorder, and
wherein the system automatically selects the Supplier and Manufacturer that produced the goods for the previous order.

26. The system for automated product design and approval of claim 24, wherein the system sends emails to the selected Supplier(s) and Manufacturer(s) informing them of the request for a quote and providing them with instructions on how to log in to the system and fill out a quote form.

27. The system for automated product design and approval of claim 26, wherein a method of production is indicated on the Manufacturer's quote form.

28. The system for automated product design and approval of claim 26, wherein the system sends an email to one or more Company Administrator(s) when quotes are submitted by the Supplier(s) and Manufacturer(s).

29. The system for automated product design and approval of claim 28, wherein a Company Administrator accepts one Supplier quote and one Manufacturer quote.

30. The system for automated product design and approval of claim 28, wherein a Company Administrator accepts one quote from a company that will be acting both as the Supplier and the Manufacturer.

31. The system for automated product design and approval of claims 29 or 30, wherein the Company Administrator completes a Company quote.

32. The system for automated product design and approval of claims 29 or 30, wherein the system comprises a Company quote form, and
wherein the system automatically completes the Company quote form based on the accepted Supplier and Manufacturer quotes.

33. The system for automated product design and approval of claim 31, wherein the system comprises a Company quote form,
wherein the system provides a table setting forth markup percentages for each Client,
wherein the system automatically applies a default markup percentage to each quote received.

34. The system for automated product design and approval of claim 32, wherein the system adds a Graphic Artist commission to the Company quote form.

35. The system for automated product design and approval of claim 32, wherein the system adds a Product Developer commission to the Company quote form.

36. The system for automated product design and approval of claim 32, wherein the Company Administrator has the ability to review and accept the Company quote or change the markup percentages and/or commissions before accepting the Company quote.

37. The system for automated product design and approval of claim 36, wherein a purchase authorization is created when a Company quote is accepted.

38. The system for automated product design and approval of claim 37, wherein the system sends an email to a Product Developer and a Client requesting approval or rejection of the purchase authorization.

39. The system for automated product design and approval of claim 38, wherein the purchase authorization subsystem comprises a purchase authorization report, and
wherein a purchase authorization is approved through the use of an embedded form in the purchase authorization report.

40. The system for automated product design and approval of claim 39, the system sends an email to a Product Developer and Company Administrator(s) when a purchase authorization is accepted.

41. The system for automated product design and approval of claim 39, wherein the system sends an email to the Supplier and Manufacturer informing them that the job has been approved for production.

42. The system for automated product design and approval of claim 39, wherein the system sends a purchase order to the Supplier and a work order to the Manufacturer when a purchase authorization is accepted.

43. The system for automated product design and approval of claim 39, wherein a design image source art file is uploaded by a Graphic Artist after the purchase authorization is approved.

44. The system for automated product design and approval of claim 39, wherein the system issues a purchase order to the Supplier and a work order to the Manufacturer.

45. The system for automated product design and approval of claim 44, wherein the Manufacturer can upload a digital image of a product sample into the work order.

46. The system for automated product design and approval of claim 44, wherein the system generates a packing slip.

47. The system for automated product design and approval of claim 46, wherein the system further comprises a click-and-drag application that allows the user to organize boxes of product by size.

48. The system for automated product design and approval of claim 46, wherein the product will be shipped to one or more receiving locations,
wherein the system sends emails to one or more Company Administrators, a Client, a Product Developer, and the receiving locations informing them that the product is being shipped.

49. The system for automated product design and approval of claim 46, wherein the system generates an electronic invoice.

50. The system for automated product design and approval of claim 49, wherein the system sends the electronic invoice together with an email to a Client and one or more Company Administrators.

51. The system for automated product design and approval of claim 1, further comprising a calendar feature.

52. The system for automated product design and approval of claim 51, wherein the system comprises a plurality of profiles corresponding to each user group, and
wherein the system selectively displays the information included in the calendar depending upon the user's profile.

53. The system for automated product design and approval of claim 51, wherein an approved purchase authorization has a ship date, and wherein an approved purchase authorization is automatically displayed on the calendar on the ship date.

54. The system for automated product design and approval of claim 53, wherein the approved purchase authorization that is displayed on the calendar includes the order number, quantity, Manufacturer and a thumbnail image of the product.

55. The system for automated product design and approval of claim 53, wherein the system automatically updates the ship date throughout the system if the ship date is changed in the calendar.

56. The system for automated product design and approval of claim 53, wherein the purchase authorization that is displayed on the calendar is automatically moved if the ship date for that purchase authorization is changed in another part of the system.

57. The system for automated product design and approval of claim 56, wherein the user is notified of the change in ship date when he or she logs into the system or accesses the calendar.

58. A method of using the system for automated product design and approval of claim 1, comprising the steps of:
creating a product template by selecting the product category and subcategory;
submitting a design request;
reviewing the image of the product that has been uploaded by the Graphic Artist after he or she completes the design work;
approving the design;
selecting the product size(s);
reviewing and approving a purchase authorization; and
receiving an electronic invoice.
